(19) United States
(12) Patent Application Publication
(10) Pub. No.: US 2026/0171067 A1
(43) Pub. Date: Jun. 18, 2026

(54) SpecMaskGIT: Real-time audio/music generation technology

(71) Applicant: SONY GROUP CORPORATION, TOKYO (JP)

(72) Inventors: ZHI ZHONG, TOKYO (JP); AKIRA TAKAHASHI, SAITAMA (JP); MARCO COMUNITA, TOKYO (JP); SHIQI YANG, TOKYO (JP); MENGJIE ZHAO, TOKYO (JP); KOICHI SAITO, NEW YORK, NY (US); YUKARA IKEMIYA, KANAGAWA (JP); TAKASHI SHIBUYA, TOKYO (JP); SHUSUKE TAKAHASHI, CHIBA (JP); YUKI MITSUFUJI, TOKYO (JP)

(21) Appl. No.: 19/232,161

(22) Filed: Jun. 9, 2025

Related U.S. Application Data
(60) Provisional application No. 63/733,628, filed on Dec. 13, 2024.

(51) Int. Cl. G10K 15/02; G10L 19/038

(52) U.S. Cl. CPC G10K 15/02; G10L 19/038

(57) ABSTRACT

Provided is an information processing system that performs a process of generating or editing audio using an AI model. The information processing system includes a Central Processing Unit (CPU) that repairs masked audio data using a generation model, extracts a mask position for subsequent iterative synthesis from repaired audio data, and generates output audio data through iterative synthesis by repeating, a predetermined number of times, the extraction of the mask position and the repair of the masked audio data.

### CROSS-REFERENCE TO RELATED APPLICATIONS/INCORPORATION BY REFERENCE

This application claims the benefit of Japanese Priority Patent Application 63/733,628 filed on Dec. 13, 2024, the entire content of which is incorporated herein by reference.

### FIELD

The present disclosure relates to audio generation and editing using artificial intelligence models, and more particularly to an information processing system that performs iterative synthesis for audio data repair using generation models.

### BACKGROUND

Artificial intelligence (AI) technology has experienced widespread adoption across various domains in recent years. Text-to-audio (TTA) technology enables the synthesis of realistic voices and sound events directly from natural language prompts. These audio generation models provide valuable support for sound design and editing in industries such as music production, filmmaking, and game development, significantly enhancing creators' workflows. Consequently, TTA technology has garnered substantial interest within the research community.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for iterative synthesis for audio data repair using generation models is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which reference numerals refer to like parts throughout.

### BRIEF DESCRIPTION OF THE DRAWINGS

FIG. 1 is a diagram illustrating a training method of a SpecVQGAN model, in accordance with an embodiment of the disclosure.

FIG. 2 is a diagram illustrating a training method (self-supervised training) of a TTA system, in accordance with an embodiment of the disclosure.

FIG. 3 is a diagram illustrating a configuration example of a TTA system, in accordance with an embodiment of the disclosure.

FIG. 4 is a flowchart illustrating a processing procedure in which a TTA system iteratively synthesizes audio data, in accordance with an embodiment of the disclosure.

FIG. 5 is a diagram illustrating a mechanism for performing time repair and bandwidth extension by a zero-shot using a TTA system, in accordance with an embodiment of the disclosure.

FIG. 6 is a diagram illustrating real-time factors on various CPU cores of a TTA system, in accordance with an embodiment of the disclosure.

FIG. 7 is a diagram illustrating audio synthesis performance and a number of iterative syntheses of a TTA system and other models, in accordance with an embodiment of the disclosure.

FIG. 8 is a diagram illustrating a relationship between Gumbel temperature and FAD score in a TTA system, in accordance with an embodiment of the disclosure.

FIG. 9 is a diagram illustrating a relationship between a number of iterative syntheses and FAD score in a TTA system, in accordance with an embodiment of the disclosure.

FIG. 10 is a diagram illustrating a curve representing a relationship between a number of learning steps and FAD score in both a verification set and a test set of AudioCaps while learning a TTA system, in accordance with an embodiment of the disclosure.

FIG. 11 is a diagram illustrating an operation in which a TTA system interpolates a mask portion of partially masked original data, in accordance with an embodiment of the disclosure.

FIG. 12 is a diagram illustrating an operation in which a TTA system generates audio data from text data, in accordance with an embodiment of the disclosure.

FIG. 13 is a diagram illustrating an operation in which a TTA system generates audio data from audio data, in accordance with an embodiment of the disclosure.

FIG. 14 is a diagram illustrating a time complement function of a TTA system, in accordance with an embodiment of the disclosure.

FIG. 15 is a diagram illustrating an operation of audio infinite generation by a TTA system, in accordance with an embodiment of the disclosure.

FIG. 16 is a diagram illustrating an operation example of changing a text prompt to a TTA system in the middle of infinite generation, in accordance with an embodiment of the disclosure.

FIG. 17 is a diagram illustrating an audio infinite continuation operation by a TTA system, in accordance with an embodiment of the disclosure.

FIG. 18 is a diagram illustrating an operation example of changing a sound source to be input into a TTA system in the middle of infinite continuation, in accordance with an embodiment of the disclosure.

FIG. 19 is a diagram illustrating an operation example of changing an input prompt to a TTA system from audio to text in the middle of infinite continuation, in accordance with an embodiment of the disclosure.

FIG. 20 is a diagram illustrating a hardware configuration example of an information processing device, in accordance with an embodiment of the disclosure.

### DETAILED DESCRIPTION

Audio generation and editing using artificial intelligence (AI) models presents significant challenges in balancing quality with computational efficiency. The present disclosure addresses these challenges by providing an information processing system, an information processing method, and a non-transitory computer-readable medium for efficiently generating and editing audio using an AI model.

In a first aspect of the disclosure, an information processing system includes a repair unit that repairs masked audio data using a generation model, and a sampler that extracts mask positions for subsequent iterative synthesis from the repaired audio data. The system generates final audio output through iterative synthesis by repeatedly extracting mask positions with the sampler and repairing the masked audio data with the repair unit for a predetermined number of iterations. The generation model employs a transformer architecture for efficient processing.

As used herein, the term “system” refers to a logical assembly of multiple devices or functional modules that implement specific functions, regardless of whether these components are housed within a single enclosure. That is, the “system” may comprise either a single device containing multiple functional components or an assembly of multiple separate devices working together.

The information processing system according to the first aspect further includes a vector quantization encoder that converts a Mel spectrogram of audio waveform data into a token sequence. The repair unit then processes the masked token sequence, while the sampler identifies mask positions from the repaired token sequence for subsequent iterations.

Additionally, the information processing system may incorporate a masking unit that applies masks to tokens at any position within a token sequence, and a loss function calculation unit that quantifies the difference between the original token sequence and the repaired token sequence produced by the generation model. This configuration enables the generation model to perform self-supervised learning for improved performance.

The information processing system may further include a frequency domain masking unit configured to mask any frequency section of audio data, allowing the repair unit to reconstruct and enhance specific frequency components of the audio signal.

Furthermore, the system may incorporate a time domain masking unit that masks specific time sections of audio data, enabling the repair unit to reconstruct temporal segments of the audio signal for applications such as audio completion or extension.

A second aspect of the present disclosure provides an information processing method comprising a repair operation for reconstructing masked audio data using a generation model, and a sampling operation for identifying mask positions for subsequent iterations based on the repaired audio data. The method generates final audio output through iterative synthesis by repeatedly performing the sampling operation to identify mask positions and the repair operation to reconstruct the masked audio data for a predetermined number of iterations.

A third aspect of the present disclosure provides a non-transitory computer-readable medium that enables a computer to function as a repair unit for reconstructing masked audio data using a generation model, and a sampler for identifying mask positions for subsequent iterations based on the repaired audio data. The non-transitory computer-readable medium facilitates the generation of final audio output through iterative synthesis by repeatedly extracting mask positions with the sampler and repairing the masked audio data with the repair unit for a predetermined number of iterations.

The non-transitory computer-readable medium according to the third aspect is defined in a computer-readable format to implement predetermined processes on a computer system. The non-transitory computer-readable medium can be provided to a computer capable of executing various program codes through computer-readable storage media such as optical disks, magnetic disks, or semiconductor memory, or through communication media such as networks. When installed on a computer via any suitable medium, the program enables the computer to perform the functions described in the first aspect of the present disclosure, thereby achieving similar operational benefits and effects.

Hereinafter, embodiments of the present disclosure will be described with reference to the drawings in the following order.
A. Introduction
B. Regarding related studies
C. TTA system according to the present disclosure
C-1. Spectrogram tokenizer and vocoder
C-2. Masked generation modeling of spectrogram
C-3. Text adjustment by sequential modeling
C-4. Iterative synthesis using Classifier-free Guidance
C-5. Zero shot repair in both time domain and frequency domain
D. Experiment
E. Experimental results
E-1. Text to audio synthesis
E-2. Repair of downstream task
F. Application examples
F-1. Basic operation
F-2. Infinite generation
F-3. Infinite continuation
G. Conclusion
H. Configuration of information processing device

A. Introduction: Recent advancements in deep-generation models, particularly iterative methods such as diffusion models and autoregressive models, have led to significant results in sound quality and controllability in TTA tasks, but at the cost of slow synthesis rates. Since the synthesis rate of an iterative method depends on the number of iterations necessary for inference, techniques for reducing the number of iterations have been introduced. For example, the compression rate of the raw audio signal is increased, or the efficiency of the spread sampler is increased. However, these iterative methods are slow in synthesis rate and consume a large amount of computing resources. This is because typically hundreds of iterations are necessary to synthesize short audio clips. Furthermore, since the model size is huge, the execution time of one iteration increases. That is, the high-quality TTA system was inefficient due to the large number of model parameters.

Masked generative image transformer (MaskGIT) is a generation model for generating or editing an image and can complement a partially missing image or generate a new image. VampNet in which this MaskGIT strategy is introduced into the audio region, has been proposed. VampNet is a masked acoustic token modeling approach to music synthesis, compression, repair, and modification, where a 10 second clip can be modified in 24 iterations, but necessitates 6 seconds for a graphics processing unit (GPU) and is still heavily loaded in non-GPU environments. VampNet is not compatible with text prompts or TTA tasks. Although MAGNET extends VampNet to text conditional audio synthesis, this method is less efficient as it necessitates 180 iterations and is even more heavily loaded than some diffusion models that necessitate only 100 iterations. Since both VampNet and MAGNET operate in the latent space of the waveform domain, it is difficult to perform frequency domain modification tasks such as bandwidth extension (BWE) in a zero-shot manner.

In summary, there is still no audio synthesis method that is compatible with text prompts, has a very efficient synthesis rate, and can flexibly cope with various downstream tasks. Therefore, the present disclosure proposes an efficient and flexible TTA system based on masked generation modeling of audio spectrograms.

The TTA system according to the present disclosure is a discrete generation model and is implemented as a generative extension of an identification audio mask transformer model. The TTA system according to the present disclosure has increased the possibility of representation learning due to the mask spectrogram modeling principle and architecture design similar to audio masked autoencoder (MAE) (MAE is a type of model that masks and inputs part of data and predicts or restores a missing part). In the TTA system according to the present disclosure, bandwidth extension is effective in the zero-shot manner.

B. Regarding related studies: It is difficult to synthesize an audio signal with a raw waveform, and the amount of calculation is enormous. Therefore, a method of first generating audio in a compressed latent space and then restoring a waveform from a latent representation is a mainstream approach of audio synthesis. Autoregressive models such as Jukebox, AudioGen, MusicGen use vector quantization (VQ) variational autoencoder (VAE) to tokenize raw audio waveform signals into the discrete latent space. Although AudioGen and MusicGen use higher compression rates than Jukebox, synthesizing 10 second clips necessitate 500 iterations and is slow.

With advances in audio representation learning, such as audio MAE, it has been found that the Mel spectrogram can effectively compress raw audio signals as they emphasize the acoustic features of sound events while maintaining sufficient detail to reconstruct the raw waveforms. The Mel spectrogram is a spectrogram having, as a frequency axis, a Mel scale based on sensation to the frequency of the human ear. Inspired by the success of the above representation learning, there already exists a way to use a discrete or continuous diffusion model for the potential Mel spectrogram space created by VAE or Spectrogram VQGAN (SpecVQGAN). However, with these diffusion models, high fidelity synthesis necessitates up to 200 iterations, which remains challenging for low resource platforms and interactive use cases. There is also a technique called “distillation” that transfers knowledge of complex models to compact and efficient models. Although distilling the diffusion model can effectively reduce the necessitated iterations, the TTA system according to the present disclosure can effectively reduce the number of iterations without distillation. For fair comparison, only a method that does not distill is described in the present specification. In the Mel-based synthesis method, the waveform signal of the audio is reconstructed from the Mel spectrogram using a neural vocoder such as HiFiGAN or BigVSAN.

To seek higher synthesis efficiency, VampNet and parallel MAGNET introduced a parallel iterative synthesis strategy of MaskGIT. MaskGIT, originally proposed for class conditional image synthesis tasks, used a bidirectional transformer model rather than a unidirectional model of the autoregressive method to reduce the number of iterations necessitated. VampNet and MAGNET reduced the number of iterations compared to the autoregressive method. However, VampNet does not support a text prompt. Also, MAGNET necessitates 180 iterations, which is even heavier than some diffusion models that necessitate only 100 iterations. In addition, VampNet and MAGNET are methods built on a waveform domain latent space, and it is difficult to deal with a frequency domain task such as bandwidth extension, and its application is limited.

C. TTA system: The TTA system according to the present disclosure provides excellent efficiency, performance, and flexibility as a result of a combination of various approaches, such as a high compression rate of the tokenizer, a small model size, and a high-speed synthesis method.

C-1. Spectrogram tokenizer and vocoder: SpecVQGAN is a generation model based on a vector quantized generative adversarial network (VQGAN). SpecVQGAN can efficiently compress audio data and reconstruct high-quality audio data.

SpecVQGAN transforms each block into a discrete code called a “token” by vector quantization that divides the spectrogram (Mel spectrogram) of audio into small blocks, encoding each block into the latent vector, and further mapping each latent vector to the nearest entry in the codebook. The codebook is a dictionary that converts a latent vector into discrete tokens and includes a large number of entries (codes). A token sequence is obtained by disposing these tokens in a matrix. The token sequence is obtained by converting high-dimensional data such as a Mel spectrogram into a low-dimensional representation and uses the token sequence to hold important features while reducing the amount of information. The SpecVQGAN can also use the codebook to retrieve the vector corresponding to each token in the token sequence to reconstruct the original Mel spectrogram.

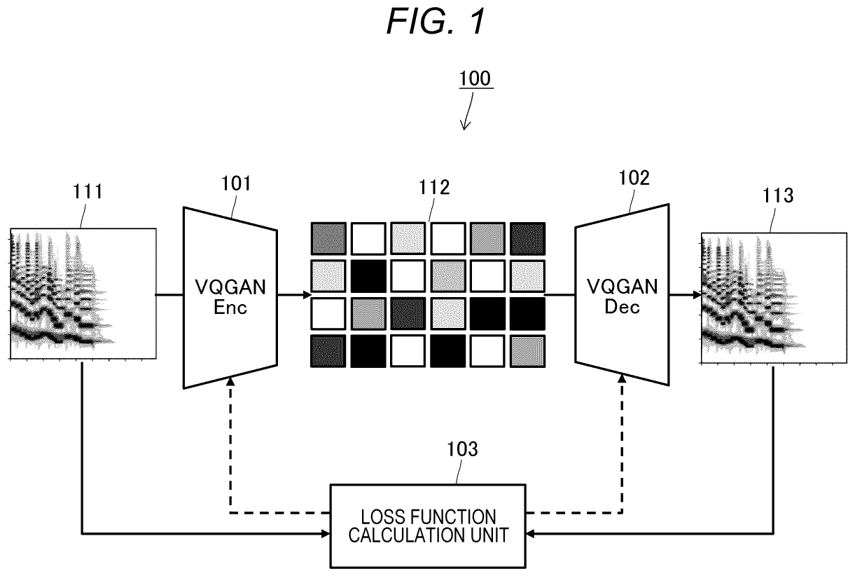

FIG. 1 is a diagram that illustrates a training method of a SpecVQGAN model 100, in accordance with an embodiment of the present disclosure. The SpecVQGAN model 100 includes a SpecVQGAN encoder (Enc) 101 and a SpecVQGAN decoder (Dec) 102. The SpecVQGAN (in FIG. 1, it is simply referred to as “VQGAN”) encoder 101 functions as a vector quantization encoder configured to encode a Mel spectrogram 111 of the original (training data) audio signal into a token sequence 112. Encoder 101 divides the Mel spectrogram 111 into small blocks, encodes each block into a latent vector, and further maps each latent vector to the nearest entry (that is, the token) in a codebook (not illustrated in FIG. 1) to convert the latent vector into a token sequence 112 with a plurality of tokens arranged in a matrix. A horizontal axis of the token sequence 112 is a time axis, and a vertical axis is a frequency axis. In FIG. 1, each token (that is, the latent vector) of the token sequence 112 is represented by shading. On the other hand, the SpecVQGAN decoder 102 reproduces a Mel spectrogram 113 from the token sequence 112 using a codebook. The reproduced Mel spectrogram 113 can be converted back to an audio signal using a vocoder (not illustrated in FIG. 1) such as HiFiGAN or BigVSAN.

In the training phase of the SpecVQGAN model 100, a loss function calculation unit 103 calculates a loss function based on an error between the Mel spectrogram 111 of the original audio signal and the Mel spectrogram 113 reproduced by the SpecVQGAN decoder 102. The model parameters of the SpecVQGAN encoder 101 and the SpecVQGAN decoder 102 and the codebook of the SpecVQGAN model 100 are then updated to optimize the loss function.

In the present embodiment, the SpecVQGAN model 100 has been trained to tokenize non-overlapping 16×16 time-Mel patches into individual tokens and convert the tokens back to the Mel spectrogram. The reconstructed Mel spectrogram is converted into a waveform by a pre-trained vocoder. In addition to the 3.2-fold compression provided by the conversion of the waveform to the Mel in this configuration, SpecVQGAN provides a 256-fold compression of the spectrogram, resulting in a total compression of more than 800-fold over the raw waveform, effectively reducing the number of tokens to be combined.

Since the hyperparameter of the Mel-transformation affects the performance of the tokenizer, in the present embodiment, the standard Mel-transformation widely used in the vocoder is used as the optimal Mel-computation. For instance, to stabilize the training, the spectrogram normalization of the original SpecVQGAN is maintained: the Mel bin below-80 dB or above 20 dB is clipped and the spectrogram is mapped to a range of −1.0 to 1.0. Experiments have shown that the modified SpecVQGAN is competitive in terms of reconstruction quality (refer section E-1).

C-2. Masked generation modeling of spectrogram: The TTA system 300 according to the present disclosure is a transformer-based masked generation model, and learning is performed in a discrete latent space created by SpecVQGAN pre-trained according to the description in section C-1.

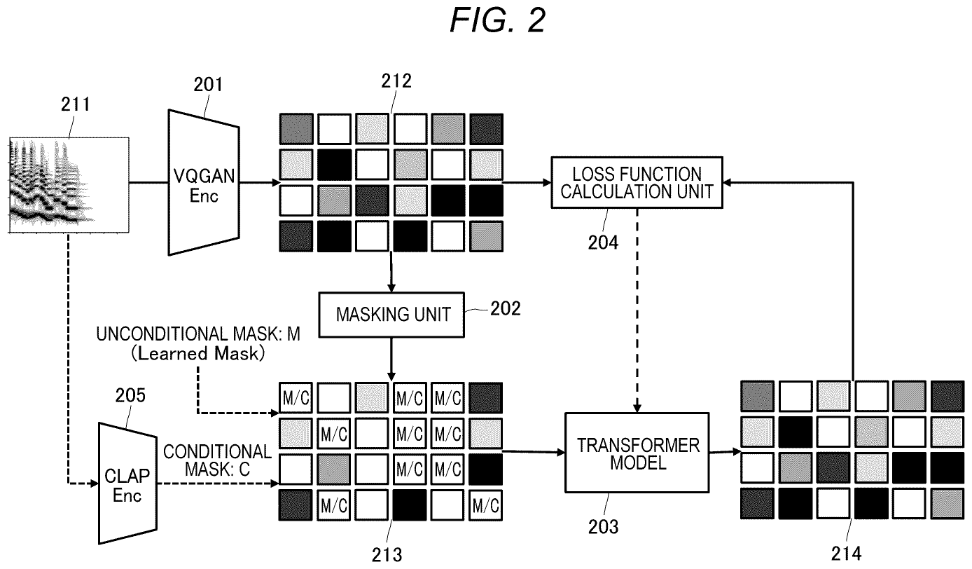

FIG. 2 illustrates a training method (self-supervised training) of a TTA system, in accordance with an embodiment of the disclosure. FIG. 2 is explained in conjunction with elements from FIG. 1. In FIG. 2, a (bidirectional) transformer model 203 corresponds to the TTA system according to the present disclosure.

It is assumed that the SpecVQGAN (in FIG. 1, it is simply referred to as “VQGAN”) encoder 201 has been pre-trained according to the training method illustrated in FIG. 1. The VQGAN encoder 201 functions as a vector quantization encoder configured to encode a Mel spectrogram of audio waveform data into a token sequence. The VQGAN encoder 201 converts an original Mel spectrogram 211 (as training data) into a token sequence 212. A masking unit 202 then masks a plurality of random locations on the token sequence 212 with a variable masking ratio. The masking unit 202 is configured to mask a token at any position in the token sequence 212. The repair unit is configured to repair masked audio data using a generation model (which includes the transformer model 203). The transformer model 203 repairs all mask positions in a masked token sequence 213 to reconstruct an unmasked token sequence 214.

A loss function calculation unit 204 calculates a loss function based on an error between the token sequence 212 encoded from the Mel spectrogram 211 and the token sequence 214 reconstructed from the masked token sequence 213 by the transformer model 203. The loss function calculation unit 204 is configured to calculate a loss function based on a difference between a second token sequence (token sequence 214) obtained by repairing, with the generation model, a masked token sequence (masked token sequence 213) obtained by masking a first token sequence (token sequence 212) by the masking unit 202 and the first token sequence (token sequence 212). The model parameters of the transformer model 203 are then updated to optimize the loss function. The generation model is configured to perform learning to optimize the loss function

Each masking position randomly masked by the masking unit 202 is masked using either a learnable mask token (Learned Mask: unconditional mask) “M” or a mask token (conditional mask) “C” applied on the basis of a specific condition. The masking unit 202 is configured to mask a token at any position in the token sequence using either an unconditional mask or a conditional mask. Although the learnable mask “M” is dynamically adjusted for the model to find the optimal masking pattern, detailed description is omitted in the present specification.

The conditional mask “C” is based on the condition output by a CLAP encoder 205. The masking unit 202 is configured to use the conditional mask based on a feature vector obtained by mapping an original Mel spectrogram of the first token sequence to a shared latent space. The contrastive language-audio pretraining (CLAP) is a model having a branch structure for mapping both audio and text to the same shared latent space and includes an audio branch that encodes audio data into feature vectors of the latent space and a text branch that encodes text data into feature vectors of the same latent space. In the present embodiment, the CLAP encoder 205 inputs the Mel spectrogram 211 of the original (as training data) audio waveform signal to output the feature vector in the latent space corresponding to this audio data and uses this output as the conditional mask “C”.

The learning method of the transformer model 203 applied to the present disclosure is similar to representation learning, such as audio MAE, in that the bidirectional transformer model is trained to reconstruct a token sequence of a Mel spectrogram from randomly masked inputs, but with two major differences from audio MAE. The first difference is that the masking ratio is not a fixed value but is sampled dynamically during training from a truncated Gaussian distribution centered at 55% and ranging from 0% to 100%. As a result, at each training step, the TTA system according to the present disclosure operates as in the audio MAE but may learn the distribution of training data from various masking ratios and gradually reduce the masking ratio over a plurality of iterations to gain the ability to iteratively refine the audio token. This is described in Section C-4.

Another difference lies in the loss function. Since audio MAE operates on a raw Mel spectrogram, mask reconstruction is optimized by mean square error. On the other hand, since the TTA system according to the present disclosure operates in a discrete latent space, the reconstruction of the mask position evolves to obtaining the correct code from the SpecVQGAN codebook, that is, to a multi-class single-label classification process. Therefore, in the present disclosure, the loss function calculation unit 204 calculates a cross entropy (CE) loss function of the prediction, prediction [mask], for the masked portion and the correct answer label, label [mask], of the similarly masked portion as illustrated in the following equation (1), and the label smoothing is a loss equal to 0.1, for example.

$$Loss = CE ( prediction [ mask ] , label [ mask ] ) \qquad ( 1 )$$

The loss function calculation unit 204 is configured to calculate the cross-entropy loss of a prediction for a masked portion and a correct answer label of the masked portion. According to the audio MAE, the visible location in the input is not considered in the loss calculation.

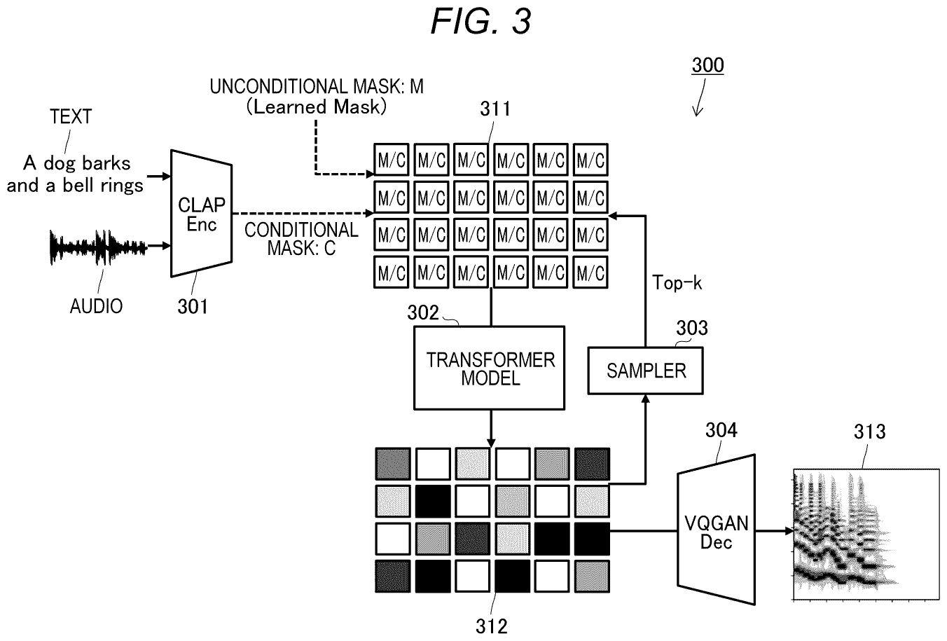

C-3. Text adjustment by sequential modeling: The TTA system according to the present disclosure learns without audio and text pairs using a pre-trained CLAP model where the audio and text feature vectors are aligned in a shared latent space. By exploiting the alignment of audio and text embedded in the shared latent space in the CLAP model, after training in the audio branch of the CLAP (as shown in FIG. 2), the pre-trained model can be inferred directly in the text branch (as shown in FIG. 3). Details of FIG. 3 are further described in subsequent section C-4. In an example embodiment, published CLAP checkpoints (“630 k-audioset-best.pt”) are used to increase reproducibility, but the present disclosure is not limited to any particular CLAP model.

Although the design of the TTA system according to the present disclosure as described above is inspired by AudioLDM, the TTA system according to the present disclosure differs in the method of inserting the CLAP condition. In addition to the FILM mechanism used in AudioLDM, in the related art, even in a method based on sequential modeling such as AudioGen or MAGNET, a text condition is inserted into a generation model through a cross-attention mechanism, and there is inevitably an operation of changing a basic DNN module. Considering that reusing the same DNN module such as the Vision transformer model (ViT) between different tasks is beneficial for efficient development, the TTA system according to the present disclosure has chosen to achieve text conditional audio synthesis by pure sequential modeling, i.e., to add the CLAP feature vector to the input sequence of the transformer model. As a result, since the TTA system according to the present disclosure can be implemented with the same ViT as used in audio MAE, the TTA system according to the present disclosure can be seen as a generative extension to the identification method of masked spectrogram modeling in the related art. Inclusion of masked spectrogram modeling and an audio MAE-like ViT implementation in a TTA system according to the present disclosure, as described in subsequent section E-2, would contribute to the possibility of representation learning.

A common method uses a learnable mask (“M” in FIG. 2) to mask the token, independent of the input. However, the mask reconstruction task is difficult because the input-independent mask does not provide better hints for reconstruction. Therefore, in the present disclosure, to further guide the mask reconstruction procedure, it is proposed to directly use the input-dependent CLAP feature vector as a conditional mask (“C” in FIG. 2). Such a conditional mask has been found to provide semantic hints that rely on inputs such as “dog barking sound” and to be beneficial to the performance of the TTA model as described in subsequent section E-1.

C-4. Iterative synthesis using Classifier-free Guidance: The TTA system according to the present disclosure follows the parallel iterative synthesis strategy generally proposed by MaskGIT but employs Classifier-free Guidance (CFG) to improve the synthesis quality. An iterative synthesis algorithm using Classifier-free Guidance (CFG) is used for the generation model. Using CFG, both the unconditional mask “M” and the conditional mask “C” are used, so that there is an effect that the model does not excessively depend on the feature “C” of the input audio or text and can generate more diverse data. The iterative synthesis model with CFG is used as follows.
(1) Data masking: a portion of the input data is masked.
(2) Generating process: masked data is input into the model and CFG is used to provide guidance.

The TTA system according to the present disclosure can synthesize a plurality of high-quality tokens for each iteration by an iterative algorithm using CFG, and the number of iterations is reduced by one order of magnitude compared to the TTA technique in the related art. Audio data to be finally output is generated by iterative synthesis in which extraction of a mask position by the sampler and repair of audio data in which the mask position is masked by the repair unit are repeated a predetermined number of times.

In the training phase, the TTA system according to the present disclosure enables CFG by replacing the CLAP feature vector mask “C” with the learnable and unconditional mask “M” to mask the token sequence in random 10% of the training step. In a training phase, a token sequence to be input into the generation model is masked by changing from the unconditional mask to the conditional mask at a predetermined ratio of training steps. In addition, in the inference phase, both the conditional (that is, in a case where the CLAP feature vector mask “C” is used) logit l_{c} and the unconditional (that is, in a case where the learnable mask “M” is used) logit lᵤ are calculated for each mask token, and these two logits are linearly combined using the guidance scale “t” as illustrated in the following equation (2) to calculate the final logit l_{g}.

$${l}_{g} = {l}_{u} + t ( {l}_{c} - {l}_{u} ) \qquad ( 2 )$$

From the equation (2), it can be intuitively understood that CFG balances diversity (l_{g}) and audio-text alignment (l_{c}). The guidance scale t is determined on the basis of experiments. In the present disclosure, with reference to a Text-to-Image model using a masked generation transformer model called Muse, a linear scheduler is introduced into the guidance scale t, and the guidance scale t is linearly increased from 0.0 to an assigned value through an iteration of synthesis. The guidance scale is configured to be increased linearly from 0.0 to an assigned value through an iteration of synthesis. This makes the results of the initial iterations more diverse (unconditional) due to the low guidance scale t, but it has proven to be beneficial to the synthesis quality with greater influence of the conditional logit l, on the subsequent synthesis. This point is also referred to in subsequent section E-1.

Note that the logit is a set of scores calculated for each output label by the model, and these scores are handled in the form of a vector, and the score functions as an intermediate value indicating the degree of reliability for each label. In an example embodiment, a label corresponds to a code or a token, and a codebook includes 1024 tokens, so that a logit at the position of a token sequence is treated as a 1024-dimensional vector. The sampler (shown in FIG. 3) is configured to extract top k tokens with poor quality from the token sequence repaired by the repair unit as mask positions for subsequent iterative synthesis.

FIG. 3 schematically illustrates a configuration example of a TTA system 300 that iteratively synthesizes audio from text, in accordance with an embodiment of the disclosure. FIG. 3 is explained in conjunction with elements from FIG. 1 and FIG. 2. The TTA system 300 includes a CLAP encoder 301, a transformer model 302, a sampler 303, and a VQGAN decoder 304.

The CLAP encoder 301 encodes text data and audio data input to the TTA system 300 into a feature vector in a shared latent space for text and audio. In the example illustrated in FIG. 3, a text prompt “A dog barks and bell rings” or a raw audio signal is input to the CLAP encoder 301. When a text prompt is input, a text branch of the CLAP encoder 301 is used, and when an audio signal is input, an audio branch of the CLAP encoder 301 is used, so that the data is encoded into a feature vector in a shared latent space. The output of the CLAP encoder 301 is used directly as a conditional mask “C” for a masked token sequence 311. Note that the “token sequence” in FIG. 3 indicates a latent space of SpecVQGAN.

Each mask position of the masked token sequence 311 is masked with either a learnable mask (“M” in FIG. 3) independent of the input of the TTA system 300 (that is, an unconditional mask) or a conditional mask (“C” in FIG. 3) using the output of the CLAP encoder 301. In a case where the TTA system 300 generates audio from scratch, the initial masked token sequence 311 is a state in which all tokens are masked, as shown in FIG. 3.

The repair unit is configured to repair masked audio data using a generation model. The transformer model 302 has been trained according to the training method shown in FIG. 2 and repairs all mask positions in the masked token sequence 311 to construct an unmasked token sequence 312.

The sampler 303 is configured to extract a mask position for subsequent iterative synthesis from audio data repaired by the repair unit. The sampler 303 extracts the top k (Top-k) tokens with poor quality from the unmasked token sequence 312 constructed by the transformer model 302. k is determined based on a masking ratio scheduled by the cosine scheduler (described below). Then, the k tokens are determined at the mask positions, and the mask position of the unmasked token sequence 312 is masked with the unconditional mask M or the conditional mask C to obtain the masked token sequence 311 to be input to the transformer model 302 in the next iteration.

Such iterative synthesis can be repeated a predetermined number of times (in the present embodiment, 16 times) to obtain the unmasked token sequence 312 that the transformer model 302 finally outputs. The VQGAN decoder 304 reproduces a Mel spectrogram 313 from the final unmasked token sequence 312. The reproduced Mel spectrogram 313 can be converted back to an audio signal using a vocoder (not illustrated in FIG. 3) such as HiFiGAN or BigVSAN.

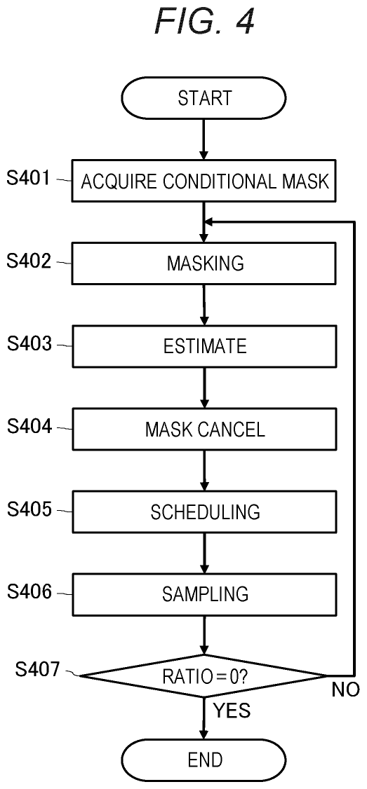

FIG. 4 illustrates a flowchart of a processing procedure in which the TTA system 300 illustrated in FIG. 3 iteratively synthesizes audio data, in accordance with an embodiment of the disclosure. FIG. 4 is explained in conjunction with elements from FIG. 1, FIG. 2, and FIG. 3.

First, the CLAP encoder 301 encodes a prompt including text data and audio data input to the TTA system 300 into a feature vector in a shared latent space for text and audio and obtains a conditional mask C (step S401).

The mask positions on the SpecVQGAN masked token sequence 311 are then determined, and each mask position is masked using either the unconditional mask M or the conditional mask C (step S402). In a case where the TTA system 300 is generating audio from scratch, the initial masked token sequence 311 is in a state where all tokens are masked, as shown in FIG. 3. On the other hand, in the second and subsequent iterative synthesis operations, the top k tokens with poor quality sampled by the sampler 303 are masked.

The transformer model 302 then repairs all mask positions in the masked token sequence 311 to construct the unmasked token sequence 312 and estimates the probability of each token being a correct code at each mask position (step S403).

Once the probability that the repaired code at each mask position is correct is obtained, the code is determined based on categorical sampling and the mask at that position is canceled (step S404). This procedure is based on categorical sampling and thus differs from the deterministic mask cancellation of the audio MAE.

It is possible to cancel the mask at all positions at once, but this would result in poor quality of the synthesized audio. Iteratively improving the synthesis requires re-masking the results at a lower masking ratio than the current iteration. Therefore, in the TTA system 300, the masking ratio for each iteration is determined using a cosine scheduler (step S405). The cosine scheduler re-masks a larger portion of the synthesized audio in initial iterations. This approach is intuitive because the quality of the initial iterations is typically poor.

Given the masking ratio of the next iteration determined in the previous step S405, the number of tokens to be re-masked is k. Therefore, the sampler 303 extracts k tokens having the worst quality from the unmasked token sequence 312 constructed by the transformer model 302 and designates these extracted tokens as mask positions for the next iteration (step S406).

In determining the top k worst tokens, the log likelihood of each token where the mask predicted by the transformer model 302 is canceled is used. In the field of image generation, it has been observed that deterministic top-k search produces monotonic images. Therefore, the confidence of each token is calculated according to the following equation (3), which adds Gumbel noise to the log likelihood of the probability p of the token. The sampler 303 extracts k tokens with lower confidence values, thereby stochastically sampling the tokens.

$$confidence = log ( p ) + {t}_{gumbel} \cdot {n}_{gumbel} \qquad ( 3 )$$

$$p = soft max ( {l}_{g} )$$

In equation (3), p is the probability of all unmasked tokens calculated from the CFG logit of equation (2) and is calculated using the SoftMax function. Additionally, n_{gumbel} is a Gumbel noise, and t_{gumbel} is a temperature parameter obtained by multiplying the Gumbel noise. Linear annealing is performed with a coefficient defined as iter/num_iter for t_{gumbel}, where “iter” represents the index of the current iteration and “num_iter” represents the scheduled number of iterations. Then, until the cosine scheduler lowers the masking ratio to 0 (No in step S407), the process returns to step S402 and repeats the above operations. When the masking ratio decreases to 0, the iterative synthesis process is terminated (Yes in step S407), and the processing is completed.

C-5. Zero shot repair in both time domain and frequency domain: In the example shown in FIG. 3, the TTA system 300 initiates the iterative procedure shown in FIG. 4 from a masking ratio of 100%, i.e., a state where the masked token sequence 311 is completely masked. This corresponds to an operation of generating audio from scratch.

The iterative procedure illustrated in FIG. 4 is also effective when starting from a state where the masking ratio is less than 100%, which corresponds to editing of original (or existing) audio data. When starting from a state in which the masking ratio is less than 100%, zero shot repair is automatically enabled in both the time domain and the frequency domain.

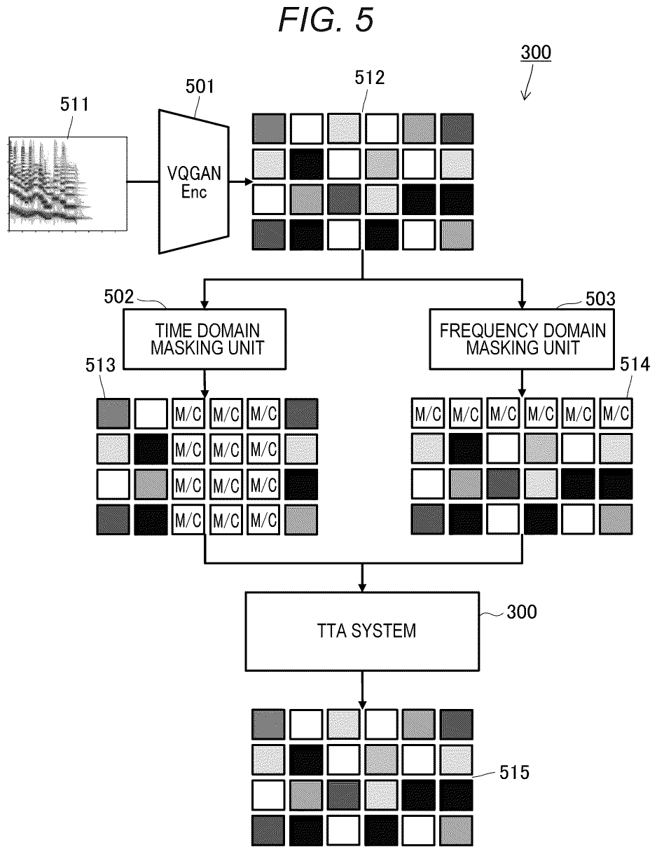

FIG. 5 illustrates a mechanism for performing time repair and bandwidth extension by a zero-shot using the TTA system 300, in accordance with an embodiment of the disclosure. FIG. 5 is explained in conjunction with elements from FIG. 1, FIG. 2, FIG. 3, and FIG. 4.

In the example illustrated in FIG. 5, time repair and bandwidth extension are performed with zero-shot on a Mel spectrogram 511 of the audio signal to be repaired. It is assumed that a VQGAN encoder 501 has been pre-trained according to the training method illustrated in FIG. 1. The VQGAN encoder 501 functions as a vector quantization encoder configured to encode the Mel spectrogram 511 into a token sequence 512.

A horizontal axis of the token sequence 512 is a time axis, and a vertical axis is a frequency axis. A time domain masking unit 502 determines the token in the time domain to be repaired in the token sequence 512 at the mask position. In the example illustrated in FIG. 5, as indicated by reference numeral 513, a time domain near the middle of the token sequence 512 is determined as the mask position. The time domain masking unit 502 can also determine the tail time domain as the mask position. In addition, a frequency domain masking unit 503 determines the token in the frequency domain to be repaired in the token sequence 512 at the mask position. In the example illustrated in FIG. 5, for super-resolution, a high frequency band of the token sequence 512 is determined as the mask position, as indicated by reference numeral 514. The frequency domain of a middle band or a low band can also be determined as the mask position. The frequency domain masking unit 503 is configured to mask any frequency section of the audio data.

When performing a zero-shot time repair on the original audio signal, the token sequence 513 masked by the time domain masking unit 502 is input to the TTA system 300. Further, when performing zero-shot frequency repair (super-resolution) on the original audio signal, the token sequence 514 masked by the frequency domain masking unit 503 is input to the TTA system 300. When the zero-shot time repair and the frequency repair are simultaneously performed, a token sequence (not illustrated) in which mask positions determined by both the time domain masking unit 502 and the frequency domain masking unit 503 are superimposed is input to the TTA system 300. Each mask position of the token sequence 513 and token sequence 514 is masked using either the learnable mask M that is independent of the original audio signal (i.e., unconditional mask) or the conditional mask C that the CLAP encoder 301 encoded from the original audio signal. Within the TTA system 300, an iterative synthesis process is performed, and the token at the mask position is repaired to reconstruct a token sequence 515.

The operation within the TTA system 300 is as previously described with reference to FIG. 3. The transformer model 302 repairs each mask position of the masked token sequence 513 or 514 to reconstruct the unmasked token sequence 515. The sampler 303 is configured to extract a mask position for subsequent iterative synthesis from audio data repaired by the repair unit. The sampler 303 extracts the top k (Top-k) tokens of poor quality from the token sequence reconstructed by the transformer model 302, inputs the token sequence in which the extracted mask position is masked to the transformer model 302, and repeats the same processing. Such iterative synthesis is repeated a predetermined number of times (in the present embodiment, 16 times), and the token sequence 515 to be finally output by the transformer model 302 is obtained. Although not illustrated in FIG. 5, the VQGAN decoder 304 reproduces the Mel spectrogram from the token sequence 515. The reproduced Mel spectrogram can be converted back to an audio signal using, for example, a vocoder such as HiFiGAN or BigVSAN.

It should be noted that since VampNet and MAGNET employ a waveform domain tokenizer, explicit frequency extension is difficult, which differs from the TTA system 300 according to the present disclosure.

D. Experiment—This Section D describes an experimental method for evaluating the performance of a TTA system 300 in accordance with an embodiment of the disclosure. The two vocoders required by the TTA system 300 (HiFiGAN and BigVSANs) are pre-trained for 1.5 million steps with AudioSet imbalance and balance subset. AudioSet is a large-scale audio-event dataset provided by Google® and is widely used in general audio representation learning. In this experiment, approximately 1.8 million 10-second audio segments of different sound sources and recording environments collected from AudioSet are used. For SpecVQGAN, the repository “VGGSound” configuration is followed without using the LPAPS loss proposed in the original repository. The SpecVQGAN (VQGAN encoder 201) used in the TTA system 300 according to the present disclosure has approximately 75 million parameters, the codebook includes 1024 tokens, and each token is represented by a 256-dimensional feature vector. As mentioned in section C-1, the standard Mel spectrogram transform of the vocoder is utilized to convert a 10-second audio clip with a sampling rate of 22.05 kHz to 848 frames with 80 Mel bins. The Mel spectrogram is further tokenized with SpecVQGAN into 265 tokens.

In an example embodiment, the TTA system 300 adopts the ViT implementation widely used in transformers with audio masks in the related art, and 24 transformer blocks are used. In this block, the attention module setup is 8 heads and 768 dimensions, and the dimensions of the feedforward module are 3072, resulting in approximately 170 million parameters. The TTA system 300 is trained for 500,000 steps with AudioSet with a batch size of 112. When training the model with AudioCaps, only 500,000 10-second audio clips are included in AudioCaps, and the model is trained for only 2.5 million steps with a batch size of 48 (AudioCaps is a dataset for audio caption generation in which natural language captions are manually attached to audio clips sampled from AudioSet). To stably train the TTA system 300, linear warm-up is employed followed by cosine annealing of the learning rate (LR) according to a standard method. Warm-up is performed for 16,000 steps when AudioSet is used, and for 5,000 steps when AudioCaps is used. The base LR is set to 1e-3, where LR is equal to a value obtained by dividing the base LR by the batch size. The iterative synthesis algorithm is based on an open-source implementation, the details of which are omitted from the disclosure for the sake of brevity.

To evaluate the text-to-audio synthesis quality of the TTA system 300, the AudioCaps test set is benchmarked using a text prompt published in AudioLDM for fair comparison. To evaluate the flexibility in the downstream task of the TTA system 300, the following “zero-shot time modification” and “zero-shot audio bandwidth extension” tasks use the TTA system 300 trained with AudioSet for 500,000 steps, for instance.

Zero-shot time modification task: the twenty-fifth to thirty-fifth Melspec frames of the AudioCaps test set (approximately 1.9 seconds) are manually masked and the TTA system 300 is used to repair lost regions in a zero-shot manner, i.e., without task-specific fine-tuning.

Zero-shot audio bandwidth extension: the top 16 Mel-spec bins (i.e., components exceeding 4.3 kHz) of the AudioCaps test set are masked, creating a 2.5× frequency extension task.

The tasks use the FAD (Fréchet Audio Distance) calculation toolbox to calculate the FAD score as a metric. This is because FAD is an index value for performance evaluation of voice generation models, which is widely used for evaluation of TTA, time repair, and frequency extension tasks (FAD converts a feature of a voice into a vector space and calculates a distance between the generated voice and a reference voice, thereby evaluating the quality and naturalness of the voice).

To explore the possibility of representation learning of the TTA system 300, the TTA system 300 is further linearly probed as a model of the music tagging task of the MagnaTagATune (MTAT) dataset, using ROC-AUC and mAP as metrics. MTAT is a widely used dataset for evaluating music tagging models to present multi-label tasks of genre, instrument, and mood. A single linear layer with batch normalization and 0.1 dropout is used as probe.

E. Experimental: In this Section E, the results of the experiment described in Section D above will be described. E-1. Text to audio synthesis: Table 1 shows the FAD scores of the TTA system 300, along with the FAD scores of other discrete models.

TABLE 1

| Method | Params | Text | Num_iter | FAD |
|---|---|---|---|---|
| Diffsound | 400M | Yes | 100 | 7.8 |
| MAGNet-small | 300M | Yes | 180 | 3.2 |
| AudioGen-base | 285M | Yes | 500 | 3.1 |
| AudioGen-l: arge | 1.5 B | Yes | 500 | 1.8 |
| TTA system (the present | | No | 16 | 2.7 |
| disclosure) | | | | |
| with HiFiGAN | 170M | | | 2.8 |
| without conditional mask | | | | 3.2 |
| without CFG | | | | 3.1 |
| without CFG linear scheduler | | | | 3.1 |

In an example embodiment, the TTA system 300 is first trained for 500,000 steps using the AudioSet and then fine-tuned for 250,000 steps in the training set using AudioCaps. The CFG scale is empirically set to 3.0. The TTA system 300 is superior to Diffsound (VQ-Diffusion), MAGNET-small (similar to TTA system 300 but operating in the latent waveform domain), and AudioGen-base (autoregressive) in terms of FAD, and requires an order of magnitude fewer iterations. The FAD score of the TTA system 300 has been achieved without training using audio and text pairs, demonstrating the performance of such self-supervised training on the TTA system 300, which is a discrete model. It is also found that the use of the conditional mask proposed in section C-3 improves the FAD score without additional parameters or calculations. Both CFG and CFG scale linear schedulers contribute to improved FAD scores.

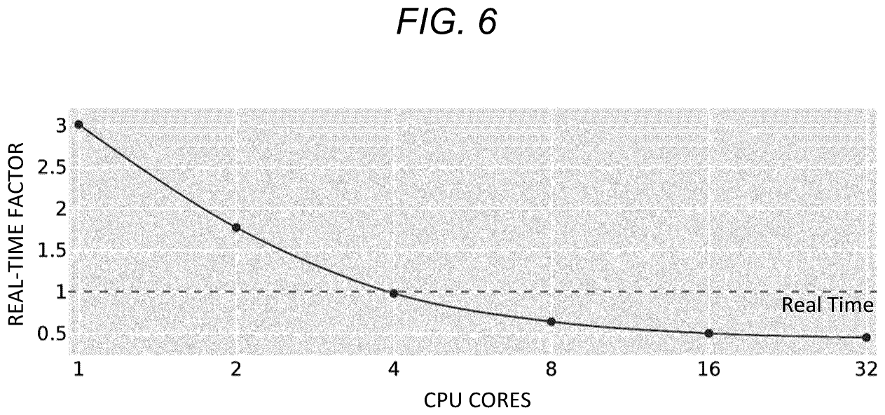

FIG. 6 illustrates real-time factors on various CPU cores using a standard implementation for the TTA system 300, in accordance with an embodiment of the disclosure. FIG. 6 is explained in conjunction with elements from FIG. 1, FIG. 2, FIG. 3, FIG. 4, and FIG. 5.

Since the TTA system 300 according to the present disclosure has a small number of iterations and a small model size, only 4 cores of a CPU are required to synthesize a 10-second audio clip in real time, or the system can synthesize the clip 30 times faster than real time with one GPU. The excellent efficiency and performance of the TTA system 300 make this model particularly suitable for interactive applications and low-resource environments.

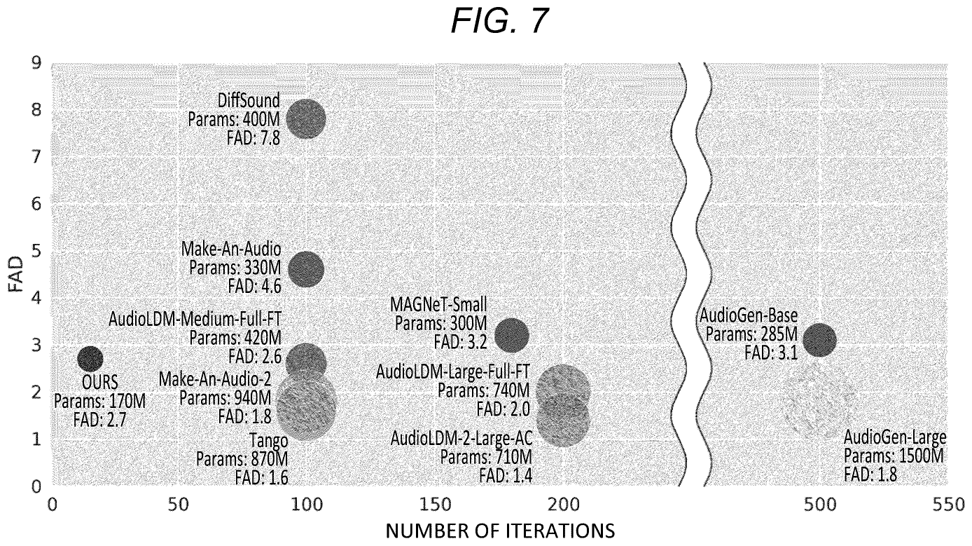

FIG. 7 illustrates audio synthesis performance and the number of iterative syntheses of the TTA system 300, in accordance with an embodiment of the disclosure. FIG. 7 is explained in conjunction with elements from FIG. 1, FIG. 2, FIG. 3, FIG. 4, FIG. 5, and FIG. 6. Compared to state-of-the-art (SOTA) continuous diffusion models, the TTA system 300 according to the present disclosure does not achieve comparable FAD scores. However, as can be seen from FIG. 7, the text to audio system 300 according to the present disclosure provides high efficiency, i.e., excellent performance with small model size and low number of iterations (the text to audio system 300 according to the present disclosure is capable of achieving appropriate audio synthesis quality with only a predetermined number of iterations, specifically 16 iterations, and a small model size).

Table 2 shows the results of the benchmark test using the test set of AudioCaps for the TTA system 300 along with the results of other models (in the table 2, a check mark in the “Dis” column indicates a discrete model, and a check mark in the “Con.” column indicates a continuous model).

TABLE 2

| Name | Parameters | Dis. | Con. | Num_iter | FAD |
|---|---|---|---|---|---|
| Diffsound | 400M | ✓ | | 100 | 7.8 |
| Make-an-Audio | 330M | | ✓ | 100 | 4.6 |
| MAGNet-small | 300M | ✓ | | 180 | 3.2 |
| AudioGen-base | 285M | ✓ | | 500 | 3.1 |
| AudioLDM- | 420M | | ✓ | 100 | 2.6 |
| Medium-full-FT | | | | | |
| AudioLDM- | 740M | | ✓ | 200 | 2.0 |
| Large-full-FT | | | | | |
| Make-an-Audio 2 | 940M | | ✓ | 100 | 1.8 |
| AudioGen-Large | 1.5 B | ✓ | | 500 | 1.8 |
| AudioLDM2-Small-AC | 350M | | ✓ | 200 | 1.7 |
| TANGO-AC | 870M | | ✓ | 100 | 1.6 |
| AudioLDM2-Large-AC | 710M | | ✓ | 200 | 1.4 |
| TTS system of | 170M | ✓ | | 16 | 2.7 |
| Present Disclosure | | | | | |

Ablation study: Gumbel noise and number of iterations: All ablation studies in the TTA system 300 use HiFiGAN. As described in section C-4, the Gumbel noise is important when the sampler 303 extracts the top k (Top-k) tokens with poor quality from the token sequence repaired by the repair unit during iterative synthesis.

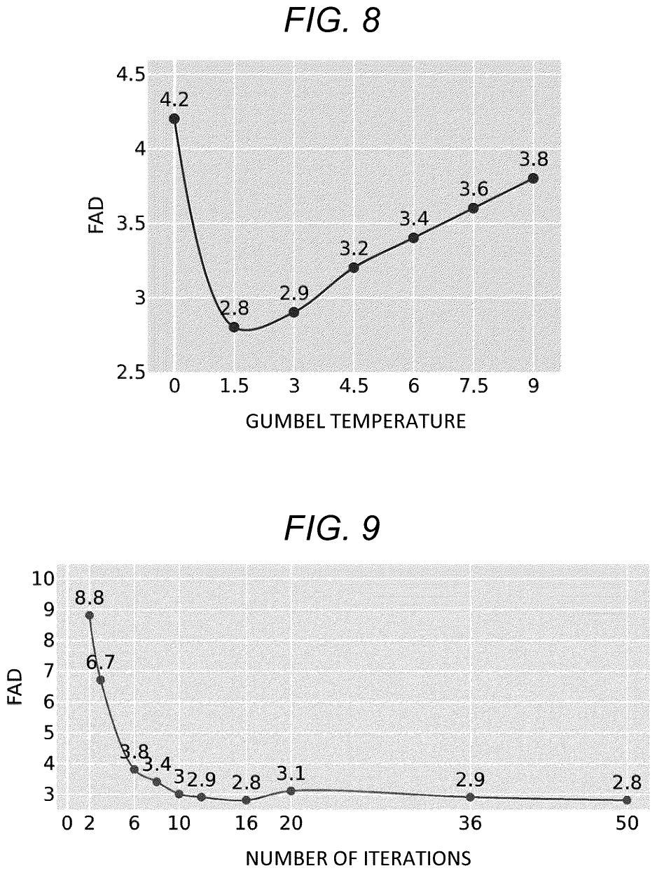

FIG. 8 illustrates a relationship between Gumbel temperature and FAD score in the TTA system 300, in accordance with an embodiment of the disclosure. FIG. 8 is explained in conjunction with elements from FIG. 1, FIG. 2, FIG. 3, FIG. 4, FIG. 5, FIG. 6, and FIG. 7. As shown in FIG. 8, in the TTA system 300, a Gumbel temperature of 1.5 provides optimal performance.

FIG. 9 illustrates a relationship between the number of iterative syntheses and FAD score in the TTA system 300, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. In FIG. 9, in the TTA system 300, adequate performance (FAD=3.4) is achieved with only 8 iterations, and the optimal performance (FAD=2.8) is reached with 16 iterations (FAD=2.7 in Tables 1 and 2 is the score when BigVSAN is used for the vocoder). Increasing the number of iterations beyond this predetermined number of times does not improve performance, which is consistent with the behavior observed in image MaskGIT.

### Ablation Studies: Audio Reconstruction Quality

To verify the audio reconstruction quality of the TTA system 300, a benchmark test using a test set of AudioCaps is performed. SpecVQGAN is used for Mel spectrogram VAE (Mel calculation) to encode a Mel spectrogram into a token sequence, and HiFiGAN and BigVSAN were used for the vocoder. Table 3 shows the results measured by the reconstruction FAD (rFAD) score. Table 3 also presents the results of similar benchmark tests performed on other models for comparison.

TABLE 3

| Method | Mel calculation | Vocoder | Latent rate | rFAD |
|---|---|---|---|---|
| Diffsound | SpecVQGAN | MelGAN | 27 Hz | 6.2 |
| Make-an-Audio | VAEGAN | HiFiGAN | 78 Hz | 6.0 |
| AudioLDM | VAEGAN | HiFiGAN | 410 Hz | 1.2 |
| Make-an-Audio 2 | VAEGAN | BigVGAN | 31 Hz | 1.0 |
| TTA system (the | — | HiFiGAN | 27 Hz | 0.4 |
| present disclosure) | SpecVQGAN | | | 1.1 |
| | — | BigVGAN | 27 Hz | 0.1 |
| | SpecVQGAN | | | 1.0 |

Diffsound and the TTA system 300 (transformer model 302) according to the present disclosure have similar architecture (SpecVQGAN) in VAE but exhibit significantly different rFAD scores due to differences in the Mel-computation method (since Mel-spec VAE) and the vocoder. The pipeline according to the present disclosure achieved state-of-the-art (SOTA) level rFAD scores in the Mel spectrogram method, while maintaining the highest compression rate or lowest potential rate, whereby the TTA system 300 according to the present disclosure achieves rFAD scores significantly exceeding those of other models, such as Diffsound and Make-an-audio, resulting in higher efficiency.

E-2. Repair of downstream task: The pipeline shown in FIG. 4 is used unconditionally with a Gumbel temperature of 1.5 and 16 iterations. The TTA system 300 according to the present disclosure significantly improved the input signal from a FAD perspective and validated the zero-shot capability for such tasks. Table 4 shows the FAD scores when audio frequency extension and time repair were performed in a zero-shot manner. By applying the low-frequency permutation (LFR) technique, the performance of the frequency extension can be further improved. Unlike prior art approaches that fine-tune architectures like MAE for frequency extension, the TTA system 300 according to the present disclosure achieves this with zero-shot capability using the frequency domain masking unit 503 configured to mask any frequency section of the audio data, wherein the repair unit is configured to repair a frequency section masked by the frequency domain masking unit 503.

TABLE 4

| | Bandwidth | Time |
|---|---|---|
| | extension | repair |
| Unprocessed | 2.7 | |
| TTA system | 1.5 | 1.2 |
| (the present disclosure) | | |
| w/LFR | 0.4 | — |
| Ground Truth | 0.0 | 0.0 |

Using ROC-AUC and mAP as metrics, the TTA system 300 according to the present disclosure is further linearly probed as a model for the music tagging task of the MTAT dataset to investigate the representation learning capabilities of the TTA system 300. Table 5 shows the evaluation results using ROC-AUC and mAP as metrics. Table 5 also presents comparative results from classification-specific models such as CLMR, MusiCNN, MULE, and MERT.

TABLE 5

| | | | Mert- | MULE- | | TTA system (the |
|---|---|---|---|---|---|---|
| Metric | CLMR | MusiCNN | 330M | contrastive | JukeBox | present disclosure |
| mAP (%) | 36.1 | 38.3 | 40.2 | 40.4 | 41.4 | 40.5 |
| ROC-AUC (%) | 89.4 | 90.6 | 91.3 | 91.4 | 91.5 | 91.5 |

From Table 5, the results confirm the performance of music tagging on the MTAT dataset. Although the TTA system 300 according to the present disclosure is a model designed to synthesize audio from text, the TTA system 300 demonstrates music tagging performance superior to classification-specific models in the prior art. The TTA system 300 according to the present disclosure achieved ROC-AUC scores comparable to Jukebox, which includes 5B parameters. The tagging functionality of the TTA system 300 is believed to derive from the masked spectrogram modeling similar to audio MAE and the ViT implementation, as described in Section C above.

F. Application examples: A primary purpose of the audio generation model is to generate, from input text, sounds (field recordings, environmental sounds, sound effects, etc.) that align with the content and nuance of the text. In general, features of the audio generation model may include the following:
(1) The generated sound has long-term continuity unlike music (low correlation).

The training data contains many short samples, and the model is not designed to generate long audio clips. For example, when producing sound effects for movies, games, or similar applications, environmental sounds (wind, fire, waves, cars, etc.) or sound effects (footsteps or similar) are often used to express a single action or a short scene.
(2) There is a need for various short samples that are easily manageable as production materials.

The TTA system 300 can generate audio from scratch with a prompt including text data or audio data as input. Furthermore, the TTA system 300 can complement masked portions by performing iterative synthesis on partially masked sound sources utilizing its generation capability.

In a single generation operation by the audio generation model, an audio clip of approximately 10 seconds is typically generated, but this length may be insufficient depending on the application. As an application example, the TTA system 300 can implement operations for infinite generation and infinite continuation of audio data.

The TTA system 300 according to the present disclosure can generate continuous sound of arbitrary length by repeatedly masking and complementing the sound source. The sound source mentioned here includes both existing sound sources and generated sound sources produced by the TTA system 300 itself. In the present specification, generation of sound continuing to an arbitrary length with respect to an existing sound source is referred to as “infinite continuation,” while generation of sound continuing to an arbitrary length with respect to a sound source generated from scratch is referred to as “infinite generation.” In Section F, infinite generation and infinite continuation of audio data is primarily introduced as application examples of the TTA system 300 according to the present disclosure. The infinite generation and infinite continuation of audio data can be implemented by applying the time repair mechanism illustrated in FIG. 5 using the time domain masking unit 502 configured to mask any time section of the audio data. The repair unit is configured to repair a time section masked by the time domain masking unit 502.

F-1. Basic operation: The TTA system 300 according to the present disclosure generates audio data by applying a process of inputting a prompt including text data and audio data and repairing partially masked original data (see FIG. 3). In the process of repairing the mask, rather than reproducing the training data, the transformer model 302 learns features common to the entire training data and extracts and reproduces elements common to the training data from the masked token (converting it into data similar to the training data). Therefore, it is unlikely that directional sound that is not represented in the training data can be generated.

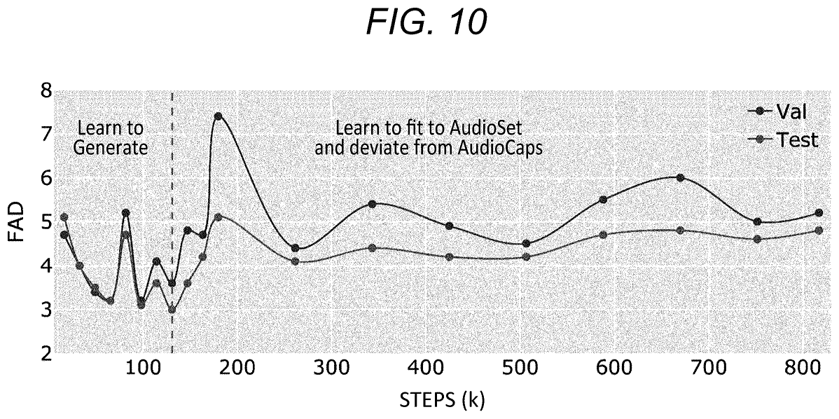

FIG. 10 is a diagram illustrating a curve representing a relationship between a number of learning steps and FAD score in both a verification set and a test set of AudioCaps while learning a TTA system 300, in accordance with an embodiment of the disclosure. FIG. 10 is explained in conjunction with elements from FIG. 1, FIG. 2, FIG. 3, FIG. 4, FIG. 5, FIG. 6, FIG. 7, FIG. 8, and FIG. 9. The graph depicts two curves representing the FAD scores for the verification set and test set as the number of learning steps increases. The horizontal axis of the graph represents the number of learning steps, ranging from approximately 100 to 800 steps. The vertical axis shows the FAD score values. Both curves exhibit a general downward trend as the number of learning steps increases, indicating improved performance of the TTA system 300 over time.

In the initial stages of learning, around 100 steps, the FAD scores for both the verification and test sets start at higher values, suggesting lower audio quality. As learning progresses, both curves show a rapid decrease in FAD scores, indicating significant improvements in audio synthesis quality. The verification set curve displays slightly more variability compared to the test set curve. This variability may be attributed to the model adapting to specific characteristics of the verification data during the learning process.

Around the 400-step mark, both curves begin to flatten, suggesting diminishing returns in performance improvements with additional learning steps. However, the overall trend continues to show gradual improvement up to 800 steps.

The test set curve generally maintains lower FAD scores compared to the verification set curve throughout the learning process. This pattern may indicate good generalization of the TTA system 300, as the performance on unseen test data closely follows or slightly outperforms the verification set results. Towards the end of the learning process, at approximately 800 steps, both curves appear to converge, with the gap between verification and test set performance narrowing. This convergence may suggest that the TTA system 300 has reached a stable level of performance across both datasets.

The progression of FAD scores illustrated in FIG. 10 demonstrates the effectiveness of the learning process for the TTA system 300. The consistent improvement in audio quality, as indicated by decreasing FAD scores, highlights the system's ability to generate increasingly realistic and high-quality audio outputs as training progresses.

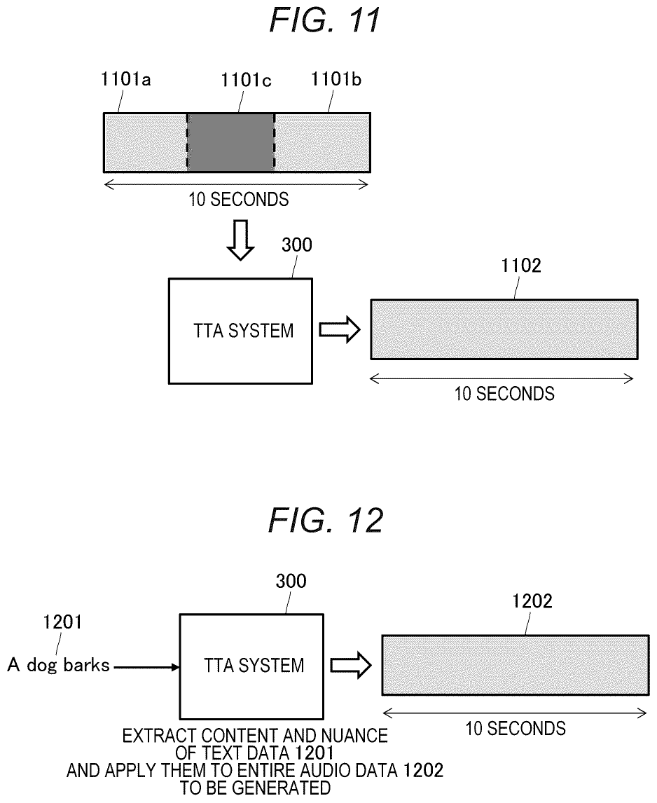

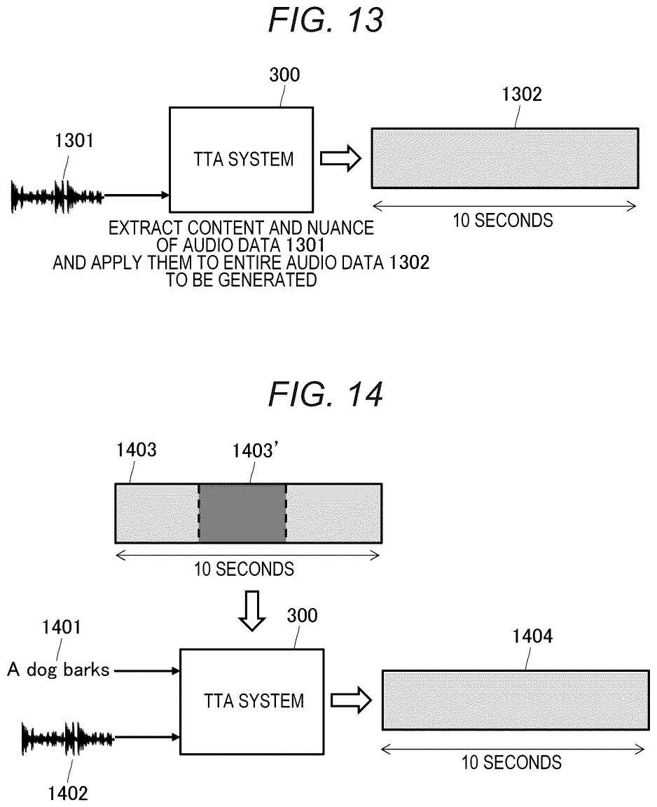

FIG. 11 schematically illustrates an operation in which the TTA system 300 according to the present disclosure interpolates a mask portion 1101c of partially masked original data to generate output audio data 1102 as a basic function, in accordance with an embodiment of the disclosure. FIG. 11 is explained in conjunction with elements from FIG. 1, FIG. 2, FIG. 3, FIG. 4, FIG. 5, FIG. 6, FIG. 7, FIG. 8, FIG. 9, and FIG. 10. The internal configuration of the TTA system 300 is as illustrated in FIG. 3, and in FIG. 11, the TTA system 300 is abstracted into one rectangular block (hereinafter, similar abstraction is used in FIGS. 12 to 19). As shown, the TTA system 300 may complement the masked portion 1101c based on information from preceding and following unmasked portions 1101a and 1101b of the partially masked original data to generate output audio data 1102. However, in instances where the original data has low correlation with the preceding and following sounds, such as a whistle, the masked portion 1101c may not be effectively complemented with the information about the preceding and following unmasked portions 1101a and 1101b. In such instances, as illustrated in FIGS. 12 and 13 to be described later, performance can be enhanced by inputting text data and audio data to the TTA system 300 during the complementation process.

FIG. 12 schematically illustrates an operation in which the TTA system 300 according to the present disclosure generates generated audio data 1202 from text data 1201, in accordance with an embodiment of the disclosure. FIG. 12 is explained in conjunction with elements from FIG. 1, FIG. 2, FIG. 3, FIG. 4, FIG. 5, FIG. 6, FIG. 7, FIG. 8, FIG. 9, FIG. 10, and FIG. 11. In this operation, the TTA system 300 extracts the content and nuance of the text data 1201 and applies them to the entire generated audio data 1202 to be generated. Typically, the generated audio data 1202 output from the TTA system 300 has a duration of 10 seconds. In the example shown in FIG. 12, a text data 1201 containing “Dog barking” is input to the TTA system 300, which then generates generated audio data 1202 comprising dog barking sounds.

FIG. 13 schematically illustrates an operation in which the TTA system 300 generates output audio signal 1302 from input audio signal 1301, in accordance with an embodiment of the disclosure. FIG. 13 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, and FIG. 12. In this operation, the TTA system 300 extracts the content and nuance of the input audio signal 1301 and applies them to the entire output audio signal 1302 to be generated. For example, when input audio signal 1301 serving as original data of a dog barking sound is input, the TTA system 300 generates output audio signal 1302 of the dog barking sound.

FIG. 14 schematically illustrates a time complement function of the TTA system 300, in accordance with an embodiment of the disclosure. FIG. 14 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, and FIG. 13. The TTA system 300 receives text input 1401 or audio input 1402 as input and applies a process of repairing partially masked original data audio sequence 1403 to generate generated audio sequence 1404 in which the masked portion 1403′ is complemented. In the example illustrated in FIG. 14, the original data audio sequence 1403 is audio data in which the intermediate time domain masked portion 1403′ of the 10-second length is masked. A text input 1401 containing “Dog barking” or audio input 1402 of a dog barking sound is input to the TTA system 300. The TTA system 300 then repairs the mask in the time domain masked portion 1403′ to generate generated audio sequence 1404 of the 10-second dog barking sound. In the TTA system 300, the partially masked original data (10-second audio) audio sequence 1403 is subjected to iterative synthesis by the transformer model 302, and the audio of the partially masked portion 1403′ is repaired based on content or nuance extracted from the input text input 1401 or audio input 1402.

Note that, in the TTA system 300, masking is actually performed on the token sequence obtained by encoding the Mel spectrogram of the audio data, but FIG. 14 illustrates the token sequence in a simplified manner. Additionally, the token sequence repaired by the transformer model 302 is decoded into a Mel spectrogram by the VQGAN decoder 304 and is further reconstructed into the generated audio sequence 1404 using a vocoder.

The input/output and complement operations of the TTA system 300 according to the present disclosure are summarized as follows: The TTA system 300 according to the present disclosure receives text data and audio data for extracting overall content and nuance of audio to be generated. The length of the input audio data is arbitrary. For example, in a case where audio having a length of 10 seconds is generated, audio data exceeding 10 seconds may be input. The TTA system 300 outputs audio data of a predetermined length (for example, 10 seconds) generated according to control information based on input data such as text data and audio data.

In the TTA system 300 according to the present disclosure, a mask is applied to a sound source to be processed. For example, in a case where the length of the sound source to be processed is 10 seconds, whereas the original data is less than 10 seconds, the length is adjusted to 10 seconds by inserting a mask. A mask can be provided at any location such as the middle, the tail, or the head of the original data. Masking the middle of the original data corresponds to “complement” of the data, masking the tail of the original data corresponds to “continuation” of the data, and masking the head of the original data corresponds to “connection” with the previous data. The TTA system 300 includes a time domain masking unit 502 configured to mask any time section of the audio data, wherein the repair unit is configured to repair a time section masked by the time domain masking unit 502.

### F-2. Infinite Generation

FIG. 12 further illustrates an operation in which the TTA system 300 generates generated audio data 1202 from scratch based on input text data 1201. Although only a short clip of approximately 10 seconds can be obtained in one generation, longer audio data may be necessary as a sound effect or an environmental sound. In such cases, the TTA system 300 according to the present disclosure may repeat the process of infinite generation, i.e., the process of masking and complementing the mask with respect to the generation sound source, to generate a sound source that continues for any desired length. The time domain masking unit 502 is configured to add a mask at a tail of a generation sound source generated by the repair unit based on a text prompt, and the repair unit is configured to generate the generation sound source that is lengthened by a time length of the tail mask by repairing the tail mask based on the text prompt.

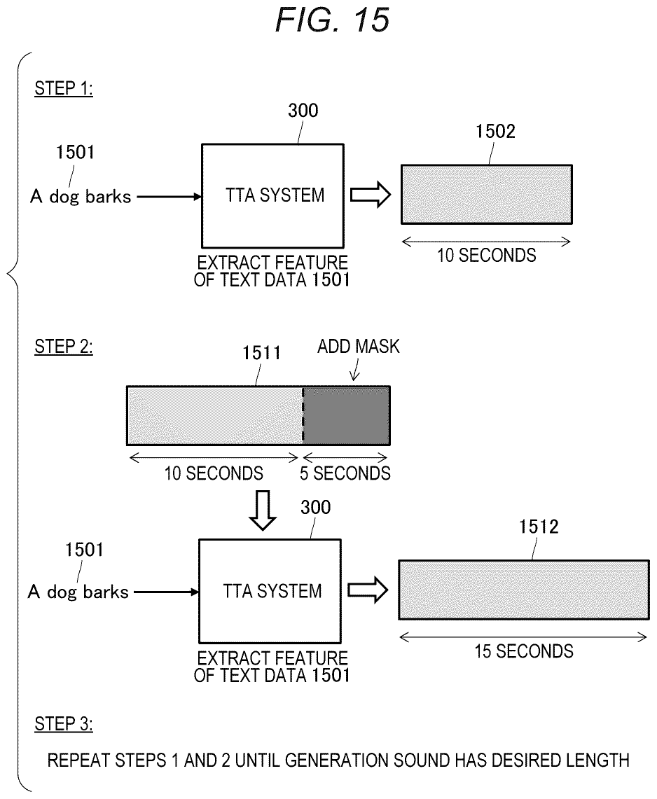

FIG. 15 illustrates an operation of audio infinite generation by the TTA system 300, in accordance with an embodiment of the disclosure. FIG. 15 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14.

Step 1: Generation—The TTA system 300 generates audio data 1502 of a dog barking sound having a length of 10 seconds by processing the text prompt 1501 containing “Dog barking”. The TTA system 300 extracts the content and nuance from the text data 1501 and applies them to the entire audio data 1502 to be generated.

Step 2: Complement—Thereafter, the TTA system 300 creates masked audio data 1511 having a total length of 15 seconds by adding a 5-second mask section at the tail of the 10-second audio data 1502 and sets this masked audio data 1511 as the next input data. The mask may be added at the tail of the audio data 1502 by the time domain masking unit 502 illustrated in FIG. 5 (hereinafter, similar). The TTA system 300 then complements the mask portion through iterative synthesis to generate audio data 1512 having a length of 15 seconds, which is longer than the original audio data 1502 by the time length of the added mask. When complementing the mask, the TTA system 300 applies the content and nuance extracted from the text data 1501 to the entire audio data 1512 to be generated. The time domain masking unit 502 is configured to add a mask at a tail of a generation sound source generated by the repair unit based on a text prompt, and the repair unit is configured to generate the generation sound source that is lengthened by a time length of the tail mask by repairing the tail mask based on the text prompt.

In the TTA system 300, a masked token sequence with a 5-second section is added at the tail of the token sequence that encodes the Mel spectrogram of the audio data 1502. Either an unconditional mask M or a conditional mask C is used for masking. After repairing the masked token sequence using the transformer model 302, the token sequence is decoded into a Mel spectrogram by the VQGAN decoder 304, and the audio data 1512 is reconstructed from the Mel spectrogram by the vocoder.

Step 3: Iteration—The above-described complement processing is repeated until the generated audio data 1512 reaches a desired length. During infinite generation of audio data by the TTA system 300, prompts such as text and audio inputs to the TTA system 300, can be modified during the generation process.

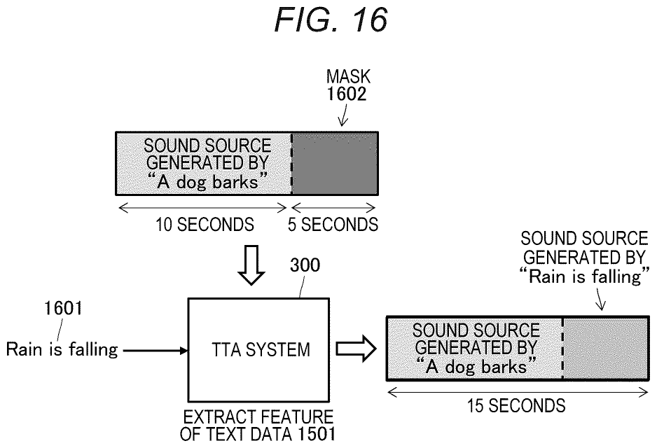

FIG. 16 illustrates an operation example of changing the text prompt to the TTA system 300 in the middle of infinite generation, in accordance with an embodiment of the disclosure. FIG. 16 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, and FIG. 15.

The TTA system 300 generates audio data with a length of 10 seconds of a dog barking sound based on a text prompt 1501 of “A Dog barks.” The content and nuance extracted from the text prompt 1501 “A Dog barks” are applied to the entire generated audio data. Subsequently, a new text prompt 1601 of “Rain is falling” is input to the TTA system 300 at the time of the next masking and complementing operation. In this case, the TTA system 300 complements the mask section 1602 with a 5-second section added at the tail of the 10-second-long audio data generated based on the features of the previous text prompt 1501 of “Dog barking” with data to which the content or nuance extracted from the new text prompt 1601 “Rain is falling” is applied. In this manner, the TTA system 300 can generate sound sources that transition between different styles. The time domain masking unit 502 is configured to add a mask at a tail of a first generation sound source generated by the repair unit based on a first text prompt, and the repair unit is configured to lengthen the first generation sound source by a time length of the tail mask by repairing the mask added at the tail of the first generation sound source with a second generation sound generated based on a second text prompt.

F-3. Infinite continuation: Audio clips such as environmental sounds and sound effects created by a creator may be short, whereas longer audio data may be necessary. In such cases, the TTA system 300 according to the present disclosure can generate a sound source that continues for any desired length by repeating the process of infinite continuation, that is, the process of masking and complementing the mask with respect to the existing sound source.

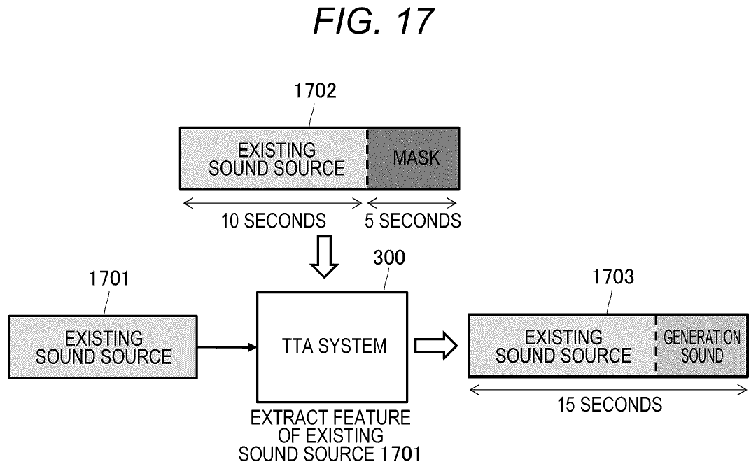

FIG. 17 illustrates an audio infinite continuation operation by the TTA system 300, in accordance with an embodiment of the disclosure. FIG. 17 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, and FIG. 16.

An existing sound source 1701, such as an audio clip produced by a creator, is input to the TTA system 300. The TTA system 300 creates masked audio data 1702 having a length of 15 seconds in which a mask with a 5-second section is added at the tail of the existing sound source 1701 having a length of 10 seconds. The TTA system 300 then complements the masked 5-second section at the tail of the masked audio data 1702 with generation sound created by applying content or nuance extracted from the existing sound source 1701 as the audio prompt, thereby generating output audio data 1703 having a length of 15 seconds. The time domain masking unit 502 is configured to add a mask at a tail of an existing sound source, and the repair unit is configured to generate the existing sound source that is lengthened by a time length of the tail mask by repairing the tail mask with a generation sound generated based on the existing sound source.

In the TTA system 300, a masked token sequence with a 5-second section is added at the tail of the token sequence in which the Mel spectrogram of the existing sound source 1701 is encoded. Either an unconditional mask M or a conditional mask C is used for masking. After repairing the masked token sequence by the transformer model 302, the token sequence is decoded into a Mel spectrogram by the VQGAN decoder 304, and output audio data 1703 having a length of 15 seconds is reconstructed from the Mel spectrogram by the vocoder. The above-described complement processing is repeated until the generated output audio data 1703 reaches a desired length.

In a case where the sound source for which infinite continuation is desired and the sound source (i.e., the audio prompt input to the TTA system 300) that provides features to be applied to the generation sound is the same existing sound source, as illustrated in FIG. 17, new generation sound can be generated while maintaining the style. Conversely, by changing the sound source desired to be continued and the sound source (i.e., the audio prompt input to the TTA system 300) from which the features to be applied to the generation sound is extracted, the TTA system 300 can continue the existing sound source with a sound source whose style changes during the continuation.

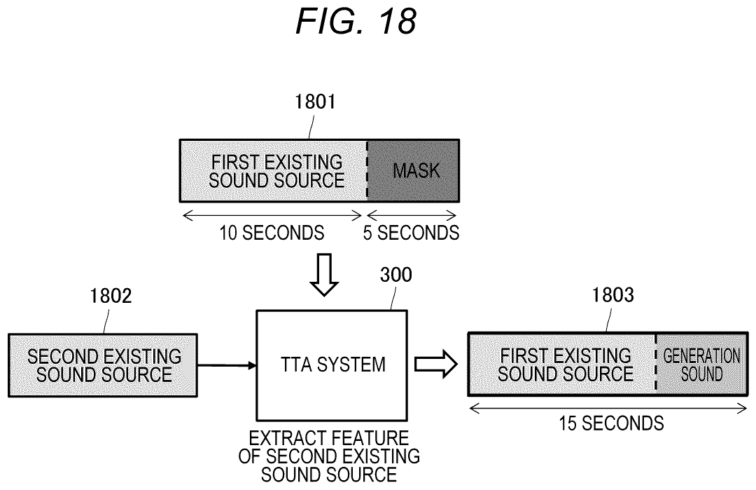

FIG. 18 illustrates an operation example of changing a sound source to be input into the TTA system 300 in the middle of infinite continuation, in accordance with an embodiment of the disclosure. FIG. 18 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, and FIG. 17.

The TTA system 300 creates masked audio data 1801 in which a mask with a 5-second section is added at the tail of a first existing sound source having a length of 10 seconds. The TTA system 300 receives a second existing sound source 1802 as an audio prompt. The TTA system 300 then iteratively synthesizes generation sound to which the content and nuance extracted from the second existing sound source 1802 are applied, complements the mask portion in the masked audio data 1801 with the generation sound, and generates output audio data 1803 having a length of 15 seconds. The output audio data 1803 includes the first existing sound source and the generation sound having a different style from the first existing sound source, wherein the style changes between the two portions. The time domain masking unit 502 is configured to add a mask at a tail of a first existing sound source, and the repair unit is configured to lengthen the first existing sound source by a time length of the tail mask by repairing the tail mask with a generation sound generated based on a second existing sound source or a text prompt.

As further application of the example illustrated in FIG. 18, by changing the input prompt to the TTA system 300 from audio to text during infinite continuation, the TTA system 300 can continue the existing sound source with a sound source having a different style, thereby creating a transition between styles.

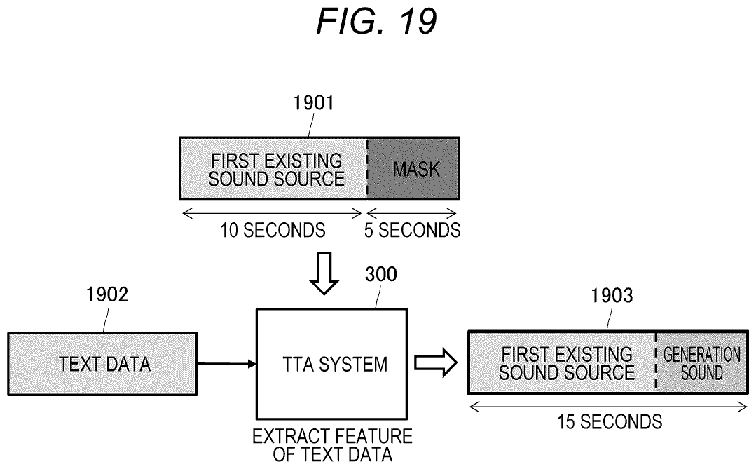

FIG. 19 illustrates an operation example of changing an input prompt to a TTA system 300 from audio to text in the middle of infinite continuation, in accordance with an embodiment of the disclosure. FIG. 19 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, and FIG. 18.

The TTA system 300 creates masked audio data 1901 in which a mask with a 5-second section is added at the tail of a first existing sound source having a length of 10 seconds. Additionally, the TTA system 300 receives a text prompt 1902 instead of using the first existing sound source as a prompt. The TTA system 300 then iteratively synthesizes generation sound to which the content and nuance extracted from the text prompt 1902 are applied, complements the mask portion in the masked audio data 1901 with the generation sound, and generates output audio data 1903 having a length of 15 seconds. The output audio data 1903 includes the first existing sound source and the generation sound having a different style from the first existing sound source, wherein the style transitions between the two portions. The time domain masking unit 502 is configured to add a mask at a tail of a first existing sound source, and the repair unit is configured to lengthen the first existing sound source by a time length of the tail mask by repairing the tail mask with a generation sound generated based on a text prompt.

Due to the high efficiency of the TTA system 300 according to the present disclosure, the functions of infinite generation and infinite continuation can be implemented in real time with reasonable computational resources.

G. Conclusion: The generation model of iteratively synthesizing audio clips has led to significant advancements in text-to-audio synthesis (TTA). However, high-quality TTA systems have remained inefficient due to the hundreds of iterations required in the inference phase and the large number of model parameters. The TTA system 300 according to the present disclosure addresses these challenges and provides a lightweight, efficient, and effective solution based on masked generation modeling of spectrograms.

In summary, the TTA system 300 according to the present disclosure has the following aspects.

(1) Efficient and effective TTA: The TTA system 300 according to the present disclosure synthesizes realistic 10-second audio clips in fewer than 16 iterations. This represents an order of magnitude reduction compared to iterative methods in the prior art (see FIG. 7). Although the TTA system 300 according to the present disclosure is a discrete generation model, it demonstrates performance superior to large-scale VQ-Diffusion (DiffSound) and autoregressive (AudioGen-base) models in TTA benchmarks. Furthermore, the TTA system 300 according to the present disclosure can be executed in real time using four CPU cores and operates 30 times faster on a graphics processing unit (GPU) (see FIG. 6).

(2) Downstream task flexibility: The TTA system 300 according to the present disclosure exhibits greater flexibility in downstream tasks such as zero-shot frequency extension, unlike prior art approaches that fine-tune architectures such as audio masked autoencoder (MAE) for frequency extension. Furthermore, the TTA system 300 according to the present disclosure can be interpreted and implemented as a generative extension of an identification audio mask transformer model from the prior art. The mask spectrogram modeling principle and architecture design similar to audio MAE are believed to contribute to the representation learning capabilities of the TTA system 300 according to the present disclosure. The TTA system 300 according to the present disclosure can also be utilized for music tagging applications.

It should be noted that the effects described in the present specification are merely exemplary, and the effects produced by the present disclosure are not limited thereto. Additionally, the present disclosure may provide further effects beyond those described herein. Features and advantages of the present disclosure will become apparent from the more detailed description of embodiments provided above and the accompanying drawings.

### H. Configuration of Information Processing Device

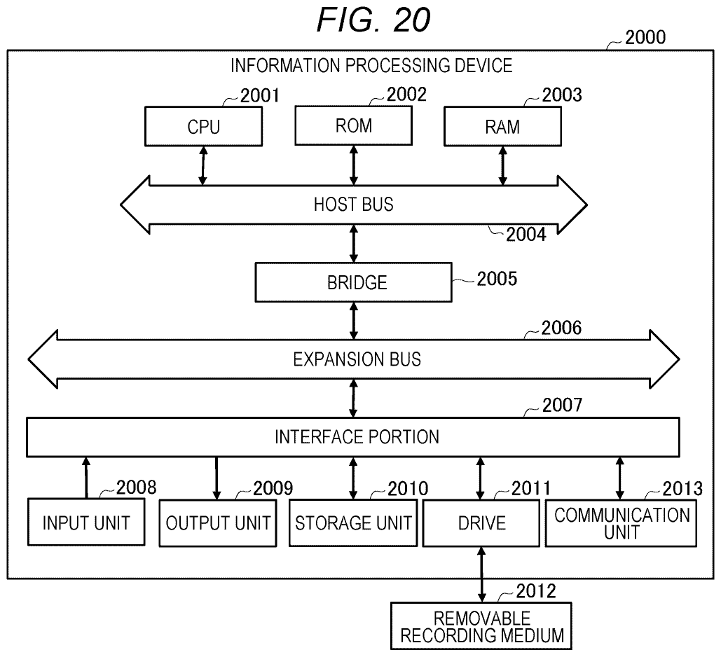

FIG. 20 illustrates a hardware configuration example of an information processing device 2000, in accordance with an embodiment of the disclosure. FIG. 20 is explained in conjunction with elements from FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, and FIG. 19. The information processing device 2000 can be used to implement the TTA system 300 according to the present disclosure and to train the SpecVQGAN model 100 and the transformer model 302 used in the TTA system 300. Furthermore, the TTA system 300 according to the present disclosure can be implemented using a single information processing device 2000 or can be implemented through cooperation of a plurality of information processing devices 2000. Additionally, benchmark testing of the TTA system 300 according to the present disclosure can be performed using the information processing device 2000.

The information processing device 2000 includes a central processing unit (CPU) 2001, a read only memory (ROM) 2002, a random-access memory (RAM) 2003, a host bus 2004, a bridge 2005, an expansion bus 2006, an interface unit 2007, an input unit 2008, an output unit 2009, a storage unit 2010, a drive 2011, and a communication unit 2013. The information processing device 2000 may comprise, for example, a personal computer (PC), although certain functions may be implemented on information terminals such as tablets or smartphones.

The CPU 2001 controls the overall operation of the information processing device 2000 according to various programs. In instances where processing with high computational requirements, such as training of an artificial intelligence (AI) model, is performed on the information processing device 2000, it is advantageous for the CPU 2001 to be a multi-core CPU (for example, Apple® M1 Max or equivalent), and for the information processing device 2000 to further include a multi-core processor (for example, “Quadro® A6000” from NVIDIA®, or equivalent) such as a GPU or a general-purpose computing on graphics processing unit (GPGPU) in addition to the CPU 2001. For convenience, these processing units are collectively referred to herein simply as the CPU 2001.

The ROM 2002 stores programs (such as a basic input/output system) and computation parameters to be used by the CPU 2001 in a nonvolatile manner. The RAM 2003 is used to load programs to be executed by the CPU 2001, and to temporarily store parameters such as working data that changes during program execution. Examples of programs loaded into the RAM 2003 and executed by the CPU 2001 include various application programs, an operating system (OS), and the like.

The CPU 2001, the ROM 2002, and the RAM 2003 are interconnected by the host bus 2004, which may include a CPU bus or the like. The CPU 2001 operates in conjunction with the ROM 2002 and the RAM 2003 to execute various application programs under an execution environment provided by the OS, thereby enabling various functions and services to be implemented. In instances where the information processing device 2000 is a PC, the OS may be, for example, Windows® of Microsoft® Corporation or Unix® or its successors. For example, the SpecVQGAN model 100 and the transformer model 302 included in the TTA system 300 according to the present disclosure are executed on the information processing device 2000.

The host bus 2004 is connected to the expansion bus 2006 via the bridge 2005. The expansion bus 2006 is, for example, a peripheral component interconnect (PCI) bus or PCI Express, and the bridge 2005 is based on the PCI standard. The information processing device 2000 does not necessarily require a configuration in which circuit components are separated by the host bus 2004, the bridge 2005, and the expansion bus 2006, and thus may be configured such that substantially all circuit components are implemented by being interconnected using a single bus (not illustrated).

The interface unit 2007 connects peripheral devices such as the input unit 2008, the output unit 2009, the storage unit 2010, the drive 2011, and the communication unit 2013 according to the standard of the expansion bus 2006. However, not all of the peripheral devices illustrated in FIG. 20 are necessarily required, and the information processing device 2000 may further include additional peripheral devices (not illustrated). Furthermore, peripheral devices may be integrated within the main body of the information processing device 2000, or certain peripheral devices may be externally connected to the main body of the information processing device 2000.

The input unit 2008 includes an input control circuit that generates an input signal based on user input and outputs the input signal to the CPU 2001. In instances where the information processing device 2000 is a PC, the input unit 2008 may include a keyboard, a mouse, and a touch panel, and may further include a camera and a microphone. The keyboard may be used, for example, to input a text prompt to the TTA system 300. The microphone may be used to input an audio prompt to the TTA system 300. The output unit 2009 includes, for example, a display device such as a liquid crystal display (LCD) device, an organic electro-luminescence (EL) display device, or a light emitting diode (LED) display, and a sound output device such as a speaker. The display device may be used to display, for example, a Mel spectrogram of an audio prompt or a Mel spectrogram generated (iteratively synthesized) by the TTA system 300. The speaker may be used for audio output of audio data generated by the TTA system 300.

The storage unit 2010 stores files such as programs (applications, OS, etc.) to be executed by the CPU 2001 and various types of data. Although the storage unit 2010 typically includes a mass storage device such as a solid-state drive (SSD) or a hard disk drive (HDD), it may also include an external storage device. For example, audio data generated by the TTA system 300 may be stored in the storage unit 2010.

The removable recording medium 2012 may include a cartridge-type storage medium such as a micro-SD card. The drive 2011 performs reading and writing operations on the removable recording medium 2012 loaded therein. The drive 2011 outputs data read from the removable recording medium 2012 to the RAM 2003 and the storage unit 2010 and writes data from the RAM 2003 and the storage unit 2010 to the removable recording medium 2012.

The communication unit 2013 is a device that performs wireless communication such as Wi-Fi (registered trademark), Bluetooth (registered trademark), or cellular communication via networks such as 4G or 5G. The communication unit 2013 may also include terminals such as Universal Serial Bus (USB) or high-definition multimedia interface (HDMI, being a registered trademark), and may further include functionality for performing HDMI communication with USB devices such as scanners, printers, displays, or the like. Programs executed on the information processing device 2000 may be installed from external sources through, for example, the communication unit 2013. Furthermore, datasets used for training or benchmark testing of the TTA system 300 according to the present disclosure may be accessed via the communication unit 2013.

### INDUSTRIAL APPLICABILITY

The present disclosure is described in detail with reference to specific embodiments. However, the present disclosure should not be construed as being limited to the above-described embodiments, and those skilled in the art can make modifications and substitutions of the embodiments without departing from the scope of the present disclosure. Additionally, the effects described in the present specification are merely exemplary, and the effects provided by embodiments of the present disclosure are not limited thereto and may include additional effects not described herein.

In the present specification, embodiments in which the present disclosure is applied to the transformer-based TTA model have been primarily described, but the scope of the present disclosure is not limited thereto. For example, the present disclosure may be applied to various other types of iterative synthesis models. Furthermore, the present disclosure enables continuous sound generation of arbitrary length with respect to an existing sound source, which can be applied to “infinite continuation,” and continuous sound generation of arbitrary length with respect to a generated sound source, which can be applied to “infinite generation.” Additionally, the present disclosure can utilize the intermediate output of the transformer model to perform music tagging and similar applications.

In summary, the present disclosure is described in an illustrative manner, and the content disclosed in the present specification should not be interpreted in a limiting manner. To determine the subject matter of the present disclosure, the claims should be taken into consideration.

The series of processing described in the present specification can be executed by hardware, software, or a configuration in which hardware and software are combined. When the processing is executed by software, a program recording the processing sequence related to implementation of the present disclosure is installed and executed in a memory incorporated in dedicated hardware in a computer. Alternatively, the program can be installed in a general-purpose computer capable of executing various types of processing and cause the computer to execute the processes related to implementation of the present disclosure.

The program can be preliminarily stored in a recording medium provided in the computer, such as an HDD, an SSD, or a ROM. Alternatively, the program can be temporarily or permanently stored in a removable recording medium such as a flexible disk, a compact disc read only memory (CD-ROM), a magneto optical (MO) disk, a digital versatile disc (DVD), a Blu-ray Disc (BD) (registered trademark), a magnetic disk, or a Universal Serial Bus (USB) memory. Such removable recording media enable the program related to implementation of the present disclosure to be provided as package software.

Additionally, the program may be transferred from a download site to a computer in a wireless or wired manner via a network such as a wide area network (WAN) typified by a cellular network, a local area network (LAN), or the Internet. The computer can receive the transferred program and install it in a mass storage device such as an HDD or an SSD in the computer.

The present disclosure may also have the following configurations:

In accordance with a first embodiment, an information processing system comprises a Central Processing Unit (CPU) configured to repair masked audio data using a generation model, extract a mask position for subsequent iterative synthesis from repaired audio data, and generate output audio data through iterative synthesis by repeating, a predetermined number of times, the extraction of the mask position and the repair of the masked audio data.

In accordance with a second embodiment, the information processing system of the first embodiment further comprises a vector quantization encoder configured to encode a Mel spectrogram of audio waveform data into a token sequence, wherein the CPU is further configured to repair a masked token sequence and extract a mask position from the repaired token sequence.

In accordance with a third embodiment, in the information processing system of the second embodiment, the generation model includes a transformer model.

In accordance with a fourth embodiment, in the information processing system of the second embodiment, the CPU is further configured to mask a token at any position in a token sequence, repair, with the generation model, a masked token sequence obtained by masking a first token sequence to obtain a second token sequence, and calculate a loss function based on a difference between the second token sequence and the first token sequence, wherein the generation model is configured to learn to optimize the loss function.

In accordance with a fifth embodiment, in the information processing system of the fourth embodiment, the CPU is further configured to calculate a cross-entropy loss of a prediction for a masked portion and a correct answer label of the masked portion.

In accordance with a sixth embodiment, in the information processing system of the fourth embodiment, the CPU is further configured to mask a token at any position in the token sequence using either an unconditional mask or a conditional mask.

In accordance with a seventh embodiment, in the information processing system of the sixth embodiment, the CPU is further configured to use the conditional mask based on a feature vector obtained by mapping an original Mel spectrogram of the first token sequence to a shared latent space.

In accordance with an eighth embodiment, in the information processing system of the sixth embodiment, an iterative synthesis method using Classifier-free Guidance (CFG) is used for the generation model.

In accordance with a ninth embodiment, in the information processing system of the eighth embodiment, in a training phase, a token sequence to be input into the generation model is masked by changing from the unconditional mask to the conditional mask at a predetermined ratio of training steps, and in an inference phase, a conditional logit and an unconditional logit calculated for each masked token are linearly combined using a guidance scale to calculate a final logit.

In accordance with a tenth embodiment, in the information processing system of the ninth embodiment, the guidance scale is configured to be increased linearly from 0.0 to an assigned value through an iteration of the iterative synthesis.

In accordance with an eleventh embodiment, in the information processing system of the ninth embodiment, the CPU is further configured to extract top k tokens with poor quality from the repaired token sequence as mask positions for the iterative synthesis.

In accordance with a twelfth embodiment, in the information processing system of the first embodiment, the CPU is further configured to mask any frequency section of the audio data and repair a frequency section masked in the audio data.

In accordance with a thirteenth embodiment, in the information processing system of the first embodiment, the CPU is further configured to mask any time section of the audio data and repair a time section masked in the audio data.

In accordance with a fourteenth embodiment, in the information processing system of the thirteenth embodiment, the CPU is further configured to add a mask at a tail of a generation sound source based on a text prompt, and generate the generation sound source that is lengthened by a time length of the tail mask by repairing the tail mask, wherein the tail mask is repaired based on the text prompt.

In accordance with a fifteenth embodiment, in the information processing system of the thirteenth embodiment, the CPU is further configured to generate a first generation sound source based on a first text prompt, generate a second generation sound source based on a second text prompt, add a mask at a tail of the first generation sound source, and lengthen the first generation sound source by a time length of the tail mask by repairing the tail mask with the second generation sound.

In accordance with a sixteenth embodiment, in the information processing system of the thirteenth embodiment, the CPU is further configured to add a mask at a tail of an existing sound source, generate a generation sound based on the existing sound source, and generate the existing sound source that is lengthened by a time length of the tail mask by repairing the tail mask with the generated generation sound.

In accordance with a seventeenth embodiment, in the information processing system of the thirteenth embodiment, the CPU is further configured to add a mask at a tail of a first existing sound source, and lengthen the first existing sound source by a time length of the tail mask by repairing the tail mask with a generation sound generated based on a second existing sound source or a text prompt.

In accordance with an eighteenth embodiment, an information processing method comprises repairing masked audio data using a generation model, extracting a mask position for subsequent iterative synthesis from repaired audio data, and generating output audio data through iterative synthesis by repeating, a predetermined number of times, the extraction of the mask position and the repair of the masked audio data.

In accordance with a nineteenth embodiment, a non-transitory computer-readable medium having stored thereon, computer-executable instructions that when executed by an information processing system, causes the information processing system to execute operations comprising repairing masked audio data using a generation model, extracting a mask position for subsequent iterative synthesis from repaired audio data, and generating output audio data through iterative synthesis by repeating, a predetermined number of times, the extraction of the mask position and the repair of the masked audio data.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 SpecVQGAN Model
101 SpecVQGAN encoder
102 SpecVQGAN decoder
103 Loss function calculation unit
201 SpecVQGAN encoder
202 Masking unit
203 Transformer model
204 Loss function calculation unit
205 CLAP encoder
300 TTA system
301 CLAP encoder
302 Transformer model
303 Sampler
304 VQGAN decoder
501 VGAN encoder
502 time domain masking unit
2000 Information processing device
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

The present disclosure may also be positioned in a computer program product, which comprises all the features that enable the implementation of the methods described herein, and which when loaded in a computer system is able to conduct these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An information processing system, comprising:
a Central Processing Unit (CPU) configured to:
repair masked audio data using a generation model;
extract a mask position for subsequent iterative synthesis from repaired audio data; and
generate output audio data through iterative synthesis by repeating, a predetermined number of times, the extraction of the mask position and the repair of the masked audio data.

2. The information processing system according to claim 1, further comprising a vector quantization encoder configured to encode a Mel spectrogram of audio waveform data into a token sequence, wherein the CPU is further configured to:
repair a masked token sequence; and
extract a mask position from the repaired token sequence.

3. The information processing system according to claim 2, wherein the generation model includes a transformer model.

4. The information processing system according to claim 2, wherein the CPU is further configured to:
mask a token at any position in a token sequence;
repair, with the generation model, a masked token sequence obtained by masking a first token sequence to obtain a second token sequence; and
calculate a loss function based on a difference between the second token sequence and the first token sequence,
wherein the generation model is configured to learn to optimize the loss function.

5. The information processing system according to claim 4, wherein the CPU is further configured to calculate a cross-entropy loss of a prediction for a masked portion and a correct answer label of the masked portion.

6. The information processing system according to claim 4, wherein the CPU is further configured to mask a token at any position in the token sequence using either an unconditional mask or a conditional mask.

7. The information processing system according to claim 6, wherein the CPU is further configured to use the conditional mask based on a feature vector obtained by mapping an original Mel spectrogram of the first token sequence to a shared latent space.

8. The information processing system according to claim 6, wherein an iterative synthesis method using Classifier-free Guidance (CFG) is used for the generation model.

9. The information processing system according to claim 8, wherein in a training phase, a token sequence to be input into the generation model is masked by changing from the unconditional mask to the conditional mask at a predetermined ratio of training steps, and in an inference phase, a conditional logit and an unconditional logit calculated for each masked token are linearly combined using a guidance scale to calculate a final logit.

10. The information processing system according to claim 9, wherein the guidance scale is configured to be increased linearly from 0.0 to an assigned value through an iteration of the iterative synthesis.

11. The information processing system according to claim 9, wherein the CPU is further configured to extract top k tokens with poor quality from the repaired token sequence as mask positions for the iterative synthesis.

12. The information processing system according to claim 1, wherein the CPU is further configured to:
mask any frequency section of the audio data; and
repair a frequency section masked in the audio data.

13. The information processing system according to claim 1, wherein the CPU is further configured to:
mask any time section of the audio data; and
repair a time section masked in the audio data.

14. The information processing system according to claim 13, wherein the CPU is further configured to:
add a mask at a tail of a generation sound source based on a text prompt; and
generate the generation sound source that is lengthened by a time length of the tail mask by repairing the tail mask, wherein the tail mask is repaired based on the text prompt.

15. The information processing system according to claim 13, wherein the CPU is further configured to:
generate a first generation sound source based on a first text prompt;
generate a second generation sound source based on a second text prompt;
add a mask at a tail of the first generation sound source; and
lengthen the first generation sound source by a time length of the tail mask by repairing the tail mask with the second generation sound.

16. The information processing system according to claim 13, wherein the CPU is further configured to:
add a mask at a tail of an existing sound source;
generate a generation sound based on the existing sound source; and
generate the existing sound source that is lengthened by a time length of the tail mask by repairing the tail mask with the generated generation sound.

17. The information processing system according to claim 13, wherein the CPU is further configured to:
add a mask at a tail of a first existing sound source; and
lengthen the first existing sound source by a time length of the tail mask by repairing the tail mask with a generation sound generated based on a second existing sound source or a text prompt.

18. An information processing method, comprising:
repairing masked audio data using a generation model;
extracting a mask position for subsequent iterative synthesis from repaired audio data; and
generating output audio data through iterative synthesis by repeating, a predetermined number of times, the extraction of the mask position and the repair of the masked audio data.

19. A non-transitory computer-readable medium having stored thereon, computer-executable instructions that when executed by an information processing system, causes the information processing system to execute operations, the operations comprising:
repairing masked audio data using a generation model;
extracting a mask position for subsequent iterative synthesis from repaired audio data; and
generating output audio data through iterative synthesis by repeating, a predetermined number of times, the extraction of the mask position and the repair of the masked audio data.
